(19) United States
(12) Patent Application Publication
(10) Pub. No.: US 2016/0127282 A1
(43) Pub. Date: May 5, 2016

(54) SYSTEM AND METHOD OF ADDING AN ANONYMOUS PARTICIPANT TO A CHAT SESSION

(71) Applicant: Avaya Inc., Santa Clara, CA (US)

(72) Inventors: Mohammad Nezarati, Richmond Hill (CA); Bryan Dingwall, Mississauga (CA)

(21) Appl. No.: 14/928,094

(22) Filed: Oct. 30, 2015

Related U.S. Application Data
(60) Provisional application No. 62/073,526, filed on Oct. 31, 2014.

(51) Int. Cl. H04L 12/58; G06F 3/0481

(52) U.S. Cl. CPC H04L 51/043; G06F 3/0481

(57) ABSTRACT

A system provides the ability for a chat or IM participant to add another participant invisibly and chat with the added participant without the knowledge of the other participants of the original chat session. A first user and a second, employing at least two devices, begin a chat or IM session. A second user initiates a side chat session with a third user. During the side chat session, the third user can selectively receive IM messages being exchanged between the first user and the second user without the knowledge of the first user. Further, the third user and second user may exchange messages that are not provided to the first user.

### CROSS REFERENCE TO RELATED APPLICATION

The present application claims the benefits of and priority, under 35 U.S.C. §119(e), to U.S. Provisional Application Ser. No. 62/073,526, filed Oct. 31, 2014, entitled “SYSTEM AND METHOD FOR ADDING AN ANONYMOUS PARTICIPANT TO A CHAT SESSION,” which is incorporated herein by this reference in its entirety for all that it teaches and for all purposes.

### FIELD OF INVENTION

The field of invention is generally related to real-time communications systems and, in particular, to chat sessions and instant messaging.

### BACKGROUND

Electronic mail (email) has been widely accepted by the business community as the preferred medium of electronic communication. However, enterprises and person-to-person communication is evolving, where the need for improved efficiency is driving the adoption of real-time communications. One drawback of e-mail is that it is a not “real-time” or, in other words, email is an “asynchronous” messaging system where there is a lag between sending and receiving an email.

Instant Messaging (IM) and/or chat are becoming increasingly popular forms of real time communication. As enterprises attempt for improved efficiency and faster turn-around times on responses, chat and IM are becoming accepted work tools to increase the effectiveness of communications. Both personally, and within businesses, chat is being used more frequently to deliver content that is part of an ongoing discussion. As such, email is being gradually replaced by IM and chat. Unfortunately, IM and chat do not have all the functionality desired by users.

### SUMMARY

The embodiments described herein provide systems and methods that allow a chat or IM participant to add another participant invisibly and chat with the added participant without the knowledge of the other participants of the original chat session.

The systems and methods can provide an environment where at least a first user and a second, employing at least two devices, can begin a chat or IM session. A second user can initiate a side chat session with a third user. During the side chat session, the third user can selectively receive IM messages being exchanged between the first user and the second user without the knowledge of the first user. Further, the third user and second user may exchange messages that are not provided to the first user.

The Aspects of the embodiments include a method comprising: a first device, including a processor, a memory, and a user interface, conduct a first chat session with a second device over a network; while conducting the first chat session, the first device receiving, through the user interface, a request to initiate a side chat session with a third device; the first device establishing a first communication channel between the first device and the third device; the first device providing access to the first communication channel by the third device; the first device registering the first communication channel with the first chat session; after registering with the first chat session, the first communication channel receiving a first message from the first chat session; the first communication channel providing the first message to the third device; and the first device preserving the anonymity of the third device with respect to the second device.

Aspects of the above method further include, wherein requesting a side chat session comprises: providing access to a list of two or more devices and/or users to invite into the side chat session; receiving an identification of the third device in the list; and inviting the third device into the side chat session.

Aspects of the above method further include, wherein the list is a contacts list stored on the first device.

Aspects of the above method further include, the third device sending a second message to the first device over the first communication channel, wherein the second message is not sent into the first chat session.

Aspects of the above method further include, wherein second device is unaware that the first device invites the third device into the side chat session.

Aspects of the above method further include, wherein the first device and the third device register with the first communication channel.

Aspects of the above method further include: the first device receiving the second message from third device; and providing the second message, along with the first message, to a user interface of the first device.

Aspects of the above method further include: the first device receiving a third message from the second device; providing the third message to the user interface of the first device; and precluding transmission of the third message to the third device in the side chat session.

Aspects of the above method further include, wherein an identity of the second device is not shared with the third device when providing the second message.

Aspects of the above method further include, wherein providing the first message to the third device further comprises: receiving selection of the first message in the user interface of the first device; in response to receiving the selection, transmitting the first message on the first communication channel to the third user.

Aspects of the embodiments include a device comprising: a user interface that: displays messages from a chat session; receives inputs from a user associated with the chat session; a memory that stores instructions to execute a side chat module; a processor in communication with the memory and the user interface, wherein the processor retrieves the instructions from the memory, wherein, based on the instructions, the processor: conducts the first chat session with a second device over a network; while conducting the first chat session, receives, through the user interface, a request to initiate a side chat session with a third device; executes the side chat module, wherein the side chat module: establishes a first communication channel between the first device and the third device; provides access to the first communication channel by the third device, wherein the first device and the third device register with the first communication channel; registers the first communication channel with the first chat session; after registering with the first chat session, provides a first message from the first chat session to the first communication channel, wherein the first communication channel provides the first message to the third device; and preserves the anonymity of the third device with respect to the second device.

Aspects of the above device further include, wherein when receiving the request for a side chat session, the user interface: provides access to a list of two or more devices and/or users to invite into the side chat session, wherein the list is a contacts list stored on the first device, wherein second device is unaware that the first device invites the third device into the side chat session; receives an identification of the third device in the list; and sends the identification to the side chat module to invite the third device into the side chat session.

Aspects of the above device further include, wherein the side chat module further: receives a second message from the third device over the first communication channel, wherein the second message is not sent into the first chat session; receives the second message from third device; and provides the second message, along with the first message, to the user interface to display together.

Aspects of the above device further include, wherein an identity of the second device is not shared with the third device when providing the second message.

Aspects of the above device further include, wherein the side chat module further: when providing the first message to the third device, receives a signal, indicating a selection of the first message, from the user interface of the first device; in response to receiving the signal, transmits the first message on the first communication channel to the third user.

Aspects of the embodiments include a user interface method, conducted on a user interface of a first device, the method comprising: providing a first window associated with a first chat session between the first device and a second device; displaying a first message, received from the second device, in the first window; displaying a first user-selectable device, in the first window, to initiate a side chat; receiving selection of the first user-selectable device to initiate a side chat session with a third device; after receiving selection of the first user-selectable device and initiation of the side chat session, displaying a second window; displaying the first message, received from the second device, in the second window; displaying a second message, received from the third device, in the second window; displaying, in the second window, a first text entry area to receive text input for a third message to be sent to the first device; and displaying, in the second window, a second text entry area to receive text input for a fourth message to be sent to the third device.

Aspects of the above method further include, wherein the first user-selectable device is a button, wherein the first user-selectable device is also displayed in the second window, and wherein a visual appearance of the first user-selectable device is different in the second window compared to when the first user-selectable device is displayed in the first window.

Aspects of the above method further include, wherein a second visual appearance of the second message is different from a first visual appearance of the first message.

Aspects of the above method further include, wherein a third visual appearance of the second text entry area is similar to a fourth visual appearance of the second message.

Aspects of the above method further include, wherein the first message and the second message are displayed in the same portion of the second window.

Phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and other media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, buffer memory, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The term “display” refers to a portion of a screen used to display the output of a computer to a user.

The term “displayed image” refers to an image produced on the display. A typical displayed image is a window or desktop. The displayed image may occupy all or a portion of the display.

The term “module” as used herein refers to any known or later developed hardware, software, firmware, artificial intelligence, fuzzy logic, or combination of hardware and software that is capable of performing the functionality associated with that element.

The term “window” refers to a, typically rectangular, displayed image on part of a display that contains or provides content different from the rest of the screen.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “device” and variations thereof, as used herein, refers to machine that may include any computing system, computing device, peripheral device, etc., which may perform the functions described herein. The devices may be as described in conjunction with at least FIGS. 10 and 11. Devices that can be advantageously used may include, but are not limited to, a personal computer (PC), which may include but not limited to a home PC, corporate PC, a Server, a laptop, a Netbook, tablet computers, a Mac, touch-screen computers running any number of different operating systems, e.g., MS Windows, Apple iOS, Google Android, Linux, Ubuntu, etc., a cellular phone, a Smartphone, a personal digital assistant (PDA), an iPhone, an iPad, an iPod, an iPad, a personal video recorder (PVR), a set top box, a wireless-enabled Blu-ray player, a television, a SmartTV, wireless enabled connected devices, e-book readers, e.g., a Kindle or a Kindle DX, a Nook, etc., and other such devices that may be capable of text, voice, video communications, etc. Other embodiments may also use devices like Samsung's Smart Window, Google Glasses, Corning's new glass technologies, and other innovations and technologies that may be applicable to the embodiments at present or in the future.

In embodiments, the device is portable. In alternative or additional embodiments, the device has a touch-sensitive display with a graphical user interface (GUI), one or more processors, memory and one or more modules, programs or sets of instructions stored in the memory for performing multiple functions. The user can interact with the GUI through finger contacts and gestures on the touch-sensitive display. In embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable medium or other computer program product configured for execution by one or more processors.

The term “content” and variations thereof, as used herein, can refer to any item of data, which may be experienced, viewed, or used by a user, and which can include an embedded URI. Content can be, for example, a webpage, a document, an application, a video, audio, etc.

The term “data store” or “database” and variations thereof, as used herein, can refer to repository of a set of data and/or data objects. The data may be modeled using structure defined in a database schema. A data store is a general concept that includes not just repositories but simpler data storage such as flat files etc.

The term “Application Programming Interface (API)” and variations thereof, as used herein, can refer to a set of routines, protocols, and tools for building or integrating software applications. An API may express a software component in terms of operations, inputs, outputs, and underlying types. An API can define functionalities that are independent of their respective implementations or target applications, which allows definitions and implementations to vary without compromising the interface to the target application.

The term “processor” or “Computer Processor Unit (CPU)” and variations thereof, as used herein, can refer to the electronic circuitry within a computer that carries out the instructions of a computer program by performing the basic arithmetic, logical, control, and input/output (I/O) operations specified by the instructions. Generally the processor can include, at least, an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers, and other components. When executing the instructions, these three elements of the processor are configured into a unique physical arrangement. Thus, when executing instructions, the processor becomes specially-designed hardware that is different from other computers.

The term “memory” and variations thereof, as used herein, can refer to any technology consisting of computer components and recording media used to retain digital data. Memory can comprise millions of transistors and/or capacitors for storing the digital data. When storing data for the systems and methods described herein, the millions of transistors and/or capacitors are configured into a unique physical arrangement. Thus, when storing data, the memory becomes specially-designed hardware that is different from other computer memories.

The term “metadata” and variations thereof, as used herein, can generally refer to data about data. Metadata can include structural metadata and descriptive metadata. Structural metadata is data about the containers of data. Descriptive metadata uses individual instances of application data or the data content. Generally, metadata can facilitate in the discovery of relevant information, more often classified as resource discovery. Metadata also helps organize electronic resources, provide digital identification, helps support archiving, and preservation of the resource. Metadata assists in resource discovery by allowing resources to be found by relevant criteria, identifying resources, bringing similar resources together, distinguishing dissimilar resources, and giving location information. URIs may be stored as metadata in content.

The term “messaging” or “instant messaging (IM)” and variations thereof, as used herein, can refer to a set of communication technologies used for text-based communication between two or more participants/devices over the Internet or other types of networks. An “IM chat” can occur in real-time. An online chat and instant messaging differs from other technologies, such as email, because IM is a real-time communication by the users. Some systems permit messages to be sent to users when those recipients are “offline”, by sending the message to an associated email account.

The term “text messaging” and variations thereof, as used herein, refers to sending and receiving short text messages using the Short Message Service (SMS). Text messaging is the act of typing and sending a brief, electronic message between two or more devices over a phone or other network. Text messaging can encompass messages containing images, videos, and sound content, which may be known as Multi-media Messaging (MMS).

The term “PSTN (Public Switched Telephone Network)” and variations thereof, as used herein, refers to the world's circuit-switched telephone networks that are operated by national, regional, or local telephony operators, providing infrastructure and services for public telecommunication. The PSTN consists of telephone lines, fiber optic cables, microwave transmission links, cellular networks, communications satellites, and undersea telephone cables, all interconnected by switching centers, thus allowing any telephone in the world to communicate with any other. Originally a network of fixed-line analog telephone systems, the PSTN is generally digital and can include mobile and fixed telephones.

The term “PBX (Private Branch Exchange)” and variations thereof, as used herein, refers a telephone exchange that serves a particular business or office, as opposed to one that a common carrier or telephone company operates for many businesses or for the general public. PBXs make connections among the internal devices of a private organization, usually a business, and also connect them to the PSTN via trunk lines. The general term “extension” is used herein to refer to any end point on the branch because an end point can include telephones, fax machines, modems, and more.

The term “application” or “app” and variations thereof, as used herein, refers to any piece of software code where the embodiments are incorporated or embodied. The software application can be implemented in a standalone configuration or in combination with other software programs and is not limited to any particular operating system or programming paradigm described herein. Thus, the embodiments cover all applications and user interactions described herein.

The term “system” and variations thereof, as used herein, refers to any device or suite of two or more devices that can be programmed and/or configured to carry out, automatically, the operations and processes described herein.

The phrase “in communication with” and variations thereof, as used herein, refers to a communicative connection or coupling between two or more devices. The communication may be conducted through, or in accordance with, any system, protocol, standard, technology, network, etc. that allows two or more devices to interact. The interaction can be through a wired or wireless interface. Further, the communication connection allows for the exchange of data, code, directives, etc. that allow the device to conduct the methods, processes, or operations described herein.

The term “user interface” and variations thereof, as used herein, refers to the space where interactions between humans and machines occur. A device user interface includes the device display or other discernible outputs (e.g., speakers, vibration devices, etc.) and input systems (e.g., touchscreens, buttons, etc.) that include the interactive aspects of computer operating systems.

The term “window” and variations thereof, as used herein, refers to a graphical control element displayed on a user interface. The window can consist a visual area containing some of the graphical user interface (GUI) of the program the GUI belongs to and may be framed by a window border or decoration. The window can display the output of and may allow input to one or more processes of one or more applications executed on a processor.

The term “user-selectable device” and variations thereof, as used herein, refers to a graphical control element that can receive user input by manipulation of an input device into a window of the application.

The term “chat” and variations thereof, as used herein, refers to a real-time online conversation between two or more devices and the users associated therewith. It is like instant messaging, but can include more than two people engaged in a session. The chat can occur in a “chat room”, i.e., a virtual online room also called a channel. Users can type messages into their devices, and their messages appear on their displays as text entries that may scroll many screens deep. At a given time, two or more people can be in a chat room. The participants can send, receive, and reply to messages from many chat users simultaneously. Non-IM types of chat include multicast transmission, usually referred to as “chat rooms”, where participants might be anonymous or might be previously known to each other (for example collaborators on a project that is using chat to facilitate communication).

In a chat, instead of one-to-one communication, users can logon to a themed based virtual room and communicate with several people only known by their screen names. By sending typed messages to the room, all connected users can read and respond. A chat room window can combine people who may only know each other based on their profile and registered screen name. If a person decides to “go private” with someone in the room, the users can select that person's name and ask to send an Instant Message. At that point, both users are simultaneously still in the room while engaging in a private IM session in a separate window. Once a screen name is known, future Instant Messages can be sent to that person by simply opening the IM service, typing in the name and then typing a message.

The term “contact list,” “buddy list,” “messenger list” and variations thereof, as used herein, refers to a small active window inside a program window that lists screen name contacts of other users who are contacts with whom a user can have a chat and/or IM conversation. A contacts list allows for quick establishment of communication between two users, whereby one user selects the name of the second user and can start sending messages thereto. A contacts list may also indicate the “presence” of another user, i.e., if that user is signed on to the service by placing some type of icon next to the name.

The term “chat session” and variations thereof, as used herein, refers to an instance of a chat room or chat conversation between two or more devices. The chat session can be perpetual or may be terminated.

The term “side chat” and variations thereof, as used herein, refers to a chat session where an anonymous user is added to another chat or IM session, which is already in progress between the two or more users. The side chat may be initiated by any user involved in the original chat or IM session and the user interface for the original chat or IM session may provide a means for initiating the side chat, for example, by clicking a button on the IM client.

The term “presence” and variations thereof, as used herein, refers to the ability to detect the electronic presence of other users who are connected to the Internet, through a PC or mobile device, and whether those users are available in real time. Presence information has wide applications in many communication services and is commonly used in applications like instant messaging clients, discussion forums, VoIP clients, etc. Presence can be a status indicator that conveys the ability and willingness of a potential communication partner. A user's client provides presence information (presence state) via a network connection to a presence service, which is stored in a personal availability record and can be made available for distribution to other users to convey the availability for communication.

The term “Instant Messaging,” IM, and variations thereof, as used herein, refers to a set of communication technologies used for text-based communication between two or more participants over the Internet or other types of networks. IM chat can occur in real-time. IM is a type of online chat which offers real-time text transmission over the Internet. Short messages are typically transmitted bi-directionally between two parties, when each user chooses to complete a thought and select “send”. Some IM applications can use push technology to provide real-time text, which transmits messages character by character, as they are composed. More advanced instant messaging can add file transfer, clickable hyperlinks, Voice over IP, or video chat. Instant messaging systems tend to facilitate connections between specified known users (often using a contact list also known as a “buddy list” or “friend list”). Depending on the IM protocol, the technical architecture can be peer-to-peer (direct point-to-point transmission) or client-server (a central server retransmits messages from the sender to the receiver). Each modern IM service generally provides its own client, either a separately installed piece of software, or a browser-based client. The clients usually only work with the IM client supplier company's service, although some IM clients allow limited functionality with other services.

IM as a service allows users to send typed messages, pictures, files, and live video with sound to a recipient based on their screen name. This exchange can go back and forth as long as both parties desire. IM provides a personal way of communicating with friends and other known contacts. To use the IM service, a user can download a program and install the program on their computer or device. There are several available IM clients, including, for example, Yahoo Messenger, Windows Live Messenger, and AIM (America Online IM).

Instant Messaging is a real-time messaging format. IM is a specialized form of ‘chat’ between people who know each other. Both IM users must be online at the same time for IM to function.

The term “communication channel” and variations thereof, as used herein, refers to a physical transmission medium, such as a wire, and/or a logical connection over a medium, such as a radio channel. A channel is used to convey an information signal, for example a digital bit stream, from one or several senders (or transmitters) to one or several receivers. A channel has a certain capacity for transmitting information. In telecommunications and/or computer networking, a communication session or a semi-permanent connection can be established before any useful data can be transferred, and where a stream of data is delivered in the same order as it was sent.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The attached figures are provided for illustrating embodiments. However, the attached figures do not limit the claims as other arrangements, configurations, implementations, etc. are possible, even modifications that change what is shown in the figures. Provided below is a non-limiting description of the attached figures:

FIG. 1 is a block diagram of an embodiment of a system for implementing a side chat session;

FIG. 2A is a block diagram of an embodiment of a software and/or hardware architecture for implementing a side chat session on a device;

FIG. 2B is a block diagram of an embodiment of a software and/or hardware architecture for implementing a side chat session on a server;

FIG. 3 is a table representing an embodiment of a data structure that stores information for implementing a side chat session;

FIG. 4 is another table representing an embodiment of a data structure that stores information for implementing a side chat session;

FIG. 5 is another table representing an embodiment of a data structure that stores information for implementing a side chat session

FIG. 6A is a first representation of an embodiment of a user interface that allows a user to establish and/or conduct a side chat session;

FIG. 6B is a first representation of an embodiment of a user interface that allows a user to establish and/or conduct a side chat session;

FIG. 6C is a first representation of an embodiment of a user interface that allows a user to establish and/or conduct a side chat session;

FIG. 6D is a first representation of an embodiment of a user interface that allows a user to establish and/or conduct a side chat session;

FIG. 6E is a first representation of an embodiment of a user interface that allows a user to establish and/or conduct a side chat session;

FIG. 6F is a first representation of an embodiment of a user interface that allows a user to establish and/or conduct a side chat session;

FIG. 7 is a flow chart of an embodiment of a method for establishing and/or conducting a side chat session by a device(s) and/or server(s);

FIG. 8 is a flow chart of an embodiment of a method for establishing and/or conducting a side chat session by a device(s) and/or server(s);

FIG. 9 is a flow chart of an embodiment of a method for establishing and/or conducting a side chat session by a device(s) and/or server(s);

FIG. 10A is a flow chart of an embodiment of a user interface method for establishing and/or conducting a side chat session by a devices;

FIG. 10B is a continuation of the flow chart in FIG. 10A of an embodiment of a user interface method for establishing and/or conducting a side chat session by a devices;

FIG. 11 is a block diagram of an embodiment of a software and/or hardware implementation of the devices, systems, computers, networks, etc. described herein;

FIG. 12 is a block diagram of an embodiment of software and/or hardware architecture for an implementation of the computing systems described herein.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

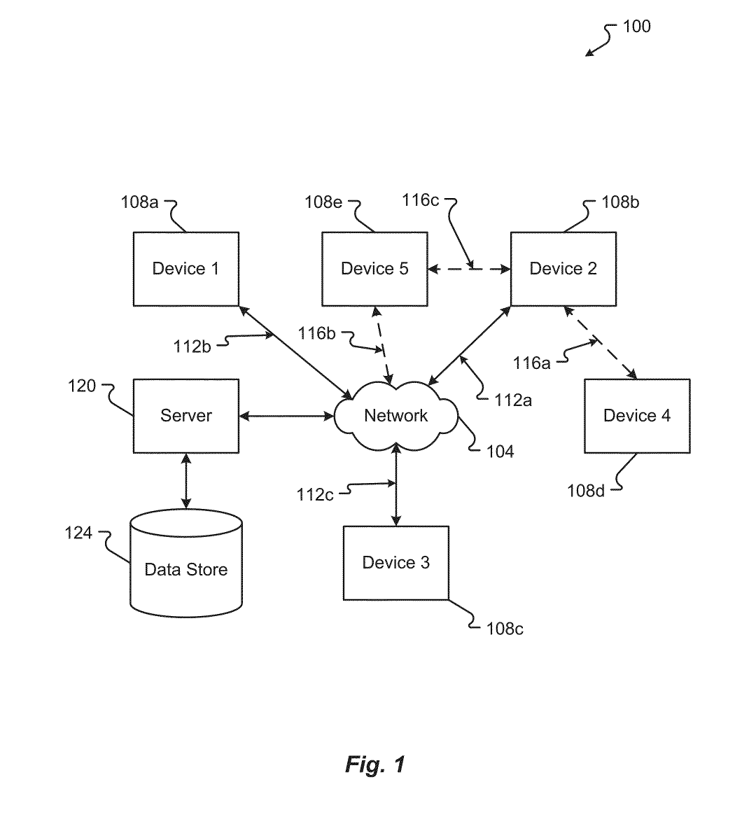

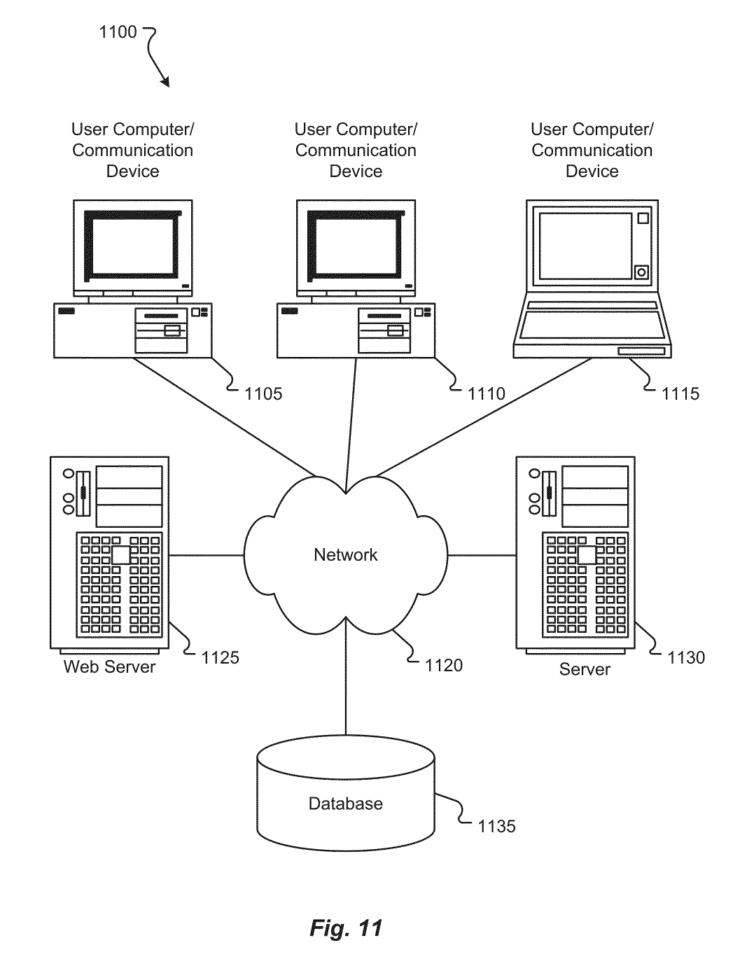

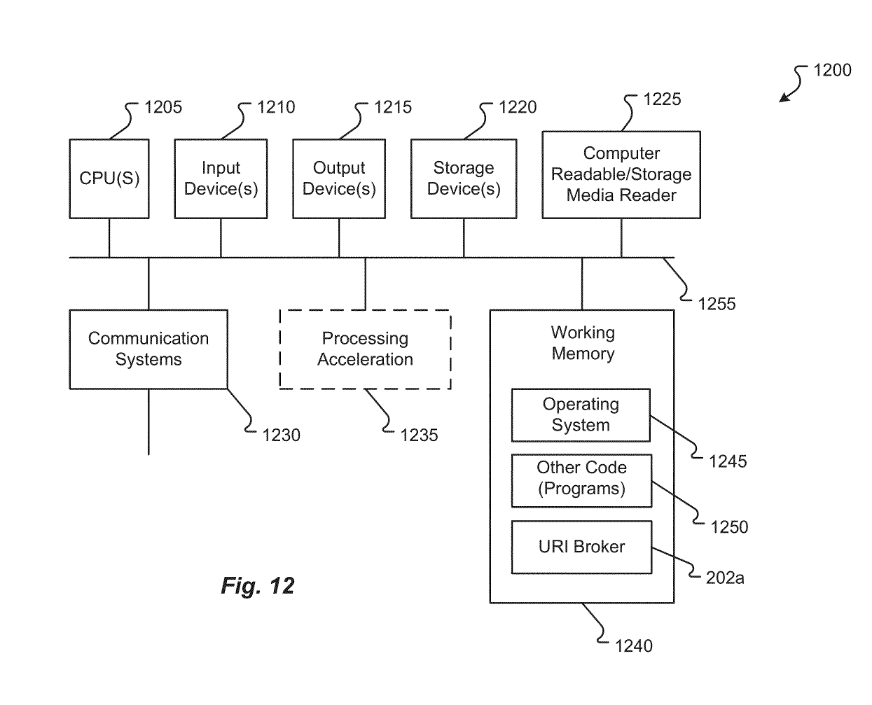

An environment 100 for conducting a chat session is as shown in FIG. 1. In the environment, one or more devices 108a-108e may communicate with each other electronically through one or more networks 104. The devices 108a through 108e may be any type of computer, mobile device, laptop, or other such electronic device as described in conjunction with FIGS. 11 and 12 or elsewhere herein. The devices 108 can communicate through network 104 using any type of protocol, standard, equipment, or other types of hardware and/or software. The communications herein may be text-based communications in a chat session or Instant Messaging environment or may include any messages required to establish or conduct a chat session or Instant Messaging session (referred to hereinafter generally as a “chat session”).

To establish a chat session, the devices 108, may communicate through the network 104 to a server 120. The server 120 may be any type of computing device as described in conjunction with FIGS. 11 and 12 or elsewhere herein. The devices 108 may register with the server 120 to establish a chat session. The server 120 may access or store any type of information to establish the chat session, in datastore 124. The chat session may include any type of electronic communication that exchanges texts, video, pictures, audio files, through a network 104 between the devices 108 either through the server 102 or excluding the server 120. Hereinafter, the chat session will be described simply as exchanging text messages of brief duration between the devices 108.

Devices 108a, 108b, and 108c may establish one or more communication channels 112a through 112c. These communication channels between the devices 108 and the network 104 are used for the chat session as registered and established by the server 120. These communication channels 112 may have characteristics or metadata associated therewith. The metadata and/or characteristics may establish the type of communication protocols or methods used with or under the communication channels 112 and can specific the type of hardware and/or software required based on and reserved for the communication of message(s) in the chat session. Thus, the devices 108a through 108c can function in a multi-device chat sessions through the network 104 as established by the devices 108 and/or the server 120.

The device 108b, after entering a first chat session, may decide to establish a side chat session with one or more devices 108d and/or 108e. The side chat session may be a separate chat session, again established by the server 120 but only includes devices 108b and devices 108d and/or 108e. The side chat session can remain anonymous to the other devices, 108a and 108c, participating in the first chat session. Thus, devices 108a and 108c may never be aware of any invitation for a side chat session nor any messages exchanged therein.

The side chat session may involve the repeating or communicating of the messages from the first chat session between devices 108a through 108c to the devices 108d and 108e in the side chat session. However, any messages generated by the devices 108d and 108e will not be shared with devices 108a or 108c, but rather, provide the messages from devices 108d and/or 108e only to device 108b. Thus, devices 108d and 108e may remain anonymous listeners of the first chat session and still be able to view messages exchanged in that first chat session through this anonymous side chat session established between device 108b and devices 108d and/or 108e.

To establish the side chat session, device 108b may create a new communication channel 116a between device 108b and device 108d. The separate channel may exchange communications through or between devices 108b and 108d. For example, the device 108b can execute the DataChannels component of the WebRTC technology to establish a peer-to-peer data channel with device 4 108d. Messages from the first chat session can be copied and relayed over the new communication channel, by a chat client or other components of device 2 108b, to a chat client on device 108d. In some instances, channel 116a may register with channel 112a to receive messages from the original chat session. However, since channel 116a does not generate any messages (as opposed to the chat clients of device 108b and 108d), no message will be provided from channel 116a to channel 112a. The chat clients resident on devices 108b and 108d may register with the channel 116a to form the side chat session. In this way, the devices 108b and 108d may exchange messages in the side chat session through channel 116a. However, channel 116a may not provide any of the exchanged messages between those devices 108b and 108d to the original chat session through channel 112a.

In other instances or circumstances, device 108b may invite device 108e into a side chat session. Here, the device 108b may send information to the server 120 to include device 108e in a separate private chat session. The server 120 may establish the new channel(s) 116b and/or 116c between the devices 108b and 108e through the network 104. The new chat session represented by channels 116b and/or 116c can allow the devices 108b and 108e to exchange chat messages. The devices 108b and 108e can register with the chat session as established by server 120, which may have different characteristics from the first chat session. For example, the characteristics of channel 116b may be that the device 108e can only receive messages but may not provide message into the first chat secession. Rather, any message from device 108e is only sent to device 2 108b. The server is thus responsible for maintaining the anonymity of device 5 108e by segregating any messages or data associated with the side chat session from devices 108a and 108c. In this way, device 108e has a one-way connection channel 116b (receive only) between the network 104 and the chat session devices 108a through 108c.

Still further, devices 108d and 108e may establish a second communication channels 116a and/or 116c to provide message between the devices 108b, 108d, and/or 108e similar to that established by communication channels 112. Thus, the devices 108b and 108e may communicate between themselves with channel 116c but may receive message in the original chat session only through channels 116b and 112a.

In other circumstances, any message sent from device 108e through channel 116b may only be sent or repeated by the server 120 to device 108d. |In this way, the channel 116b is a two-way communication channel, however, any messages from 108e sent in regards to the chat session may only be repeated or sent to the device 108b that invited and established the side chat session with device 108e. By the previous establishment of a side chat session, the device 108b may communicate anonymously with another device 108d, 108e and be able to provide messages of the original chat session to those devices 108a and 108c without devices 108d, 108e being seen or identified by devices 108a and 108c.

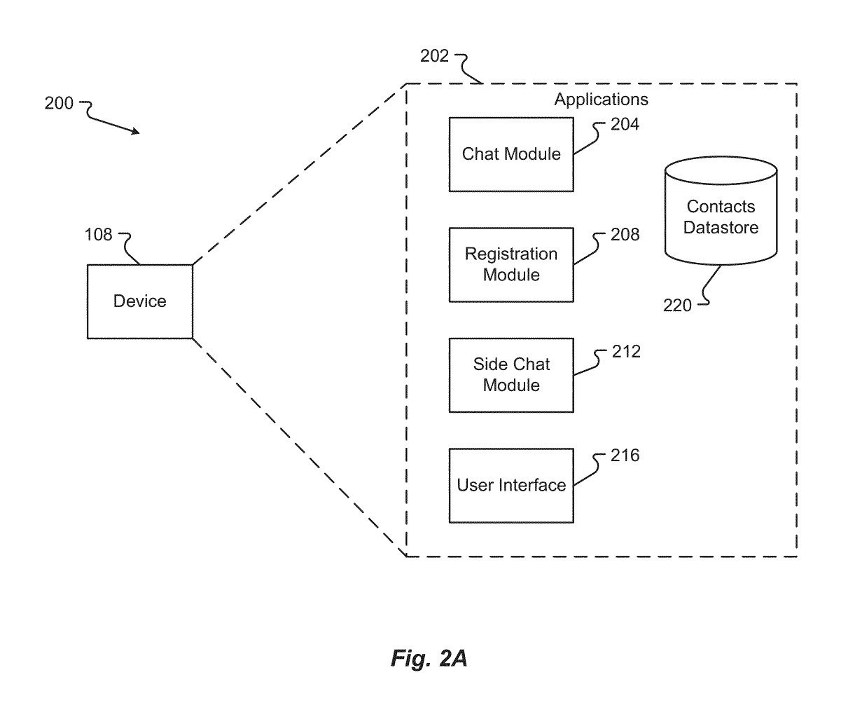

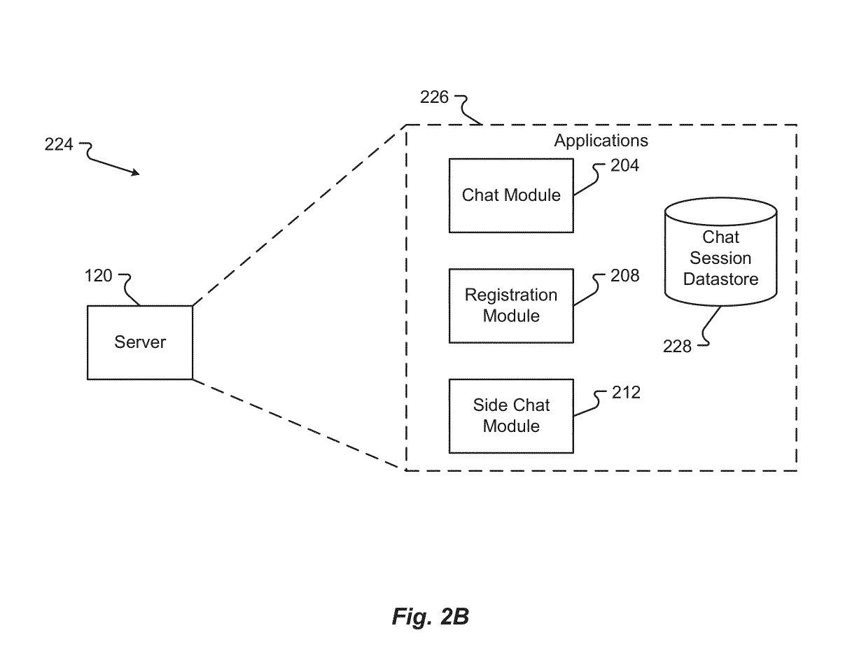

An embodiment of software and/or hardware system 200 including a suite of components 202 to conduct the chat session and/or the side chat session by a device 108 is shown in FIG. 2A. The components 202 may be associated with one or more of the devices 108 as shown and described in conjunction with FIG. 1. The components 202 may be specific hardware, general-purpose hardware, and/or software executing on specially-designed processor or other type of electronic device, component, circuit, hardware, etc., as described herein. The components 202 may include a chat module 204, a registration module 208, a side chat module 212, and/or a user interface module 216. Further, the one or more modules 204 through 216 may interface with or be in communication with the database or datastore 220. The datastore 220 may include a flat file database, an object oriented database, or other type of database configured and/or programmed to store, receive, record, and retrieve data. In some circumstances, the datastore 220 can store a listing of contacts and information about those contacts including person names, identifiers, device addresses or phone numbers, and other types of information used to establish chat sessions. Further, the datastore 220 may store information required to establish and/or conduct a chat session and/or a side chat session.

The chat module 204 can communicate with the server 120 and/or one or more other devices 108. The chat module 204 may send any information and/or receive information to establish and conduct a chat session with another device 108 whether through a network 104 using a server 120 or through a separate communications channel. The chat module 204 may communicate information, about the device 108 which is executing the chat module, to the server 120 or other devices 108, can receive messages from one or more other devices 108, and may send message received through a user interface module 216 to the one or more other devices 108. Thus, the chat module 204 includes any software and/or hardware required to conduct the chat session.

The registration module 208 may interface with the chat module 204 to register the device 108 with the server 120 or other devices 108. The registration model 208 may provide any information about the device 108 to the server 120 or to another device 108 to establish a side chat session. Thus, the registration module 208 may store information, retrieve that information, which may be associated with data or metadata about the device 108 that is required to establish the chat session or the side chat session.

The side chat module 212 may be a subcomponent of the chat module 204 or may be separate distinct module. The side chat module 212 can establish a side chat session with a separate device (e.g., 108d, 108e) while conducting an initial first chat session. The side chat module 212 can interface with the registration module 208 to provide any information to one or more devices 108 or the server 120 to establish the side chat session. Further, the side chat module 212 may access the datastore 220 to provide or retrieve any information about contacts to the user interface module 216 or other modules 204, 208 to establish the side chat session.

The user interface module 216 can provide user interfaces to conduct any of the different processes conducted by the other modules 204 through 212. The user interface module 216 may generate and/or render any type of user interface associated with the device 108 to provide information to the user or to receive input from the user.

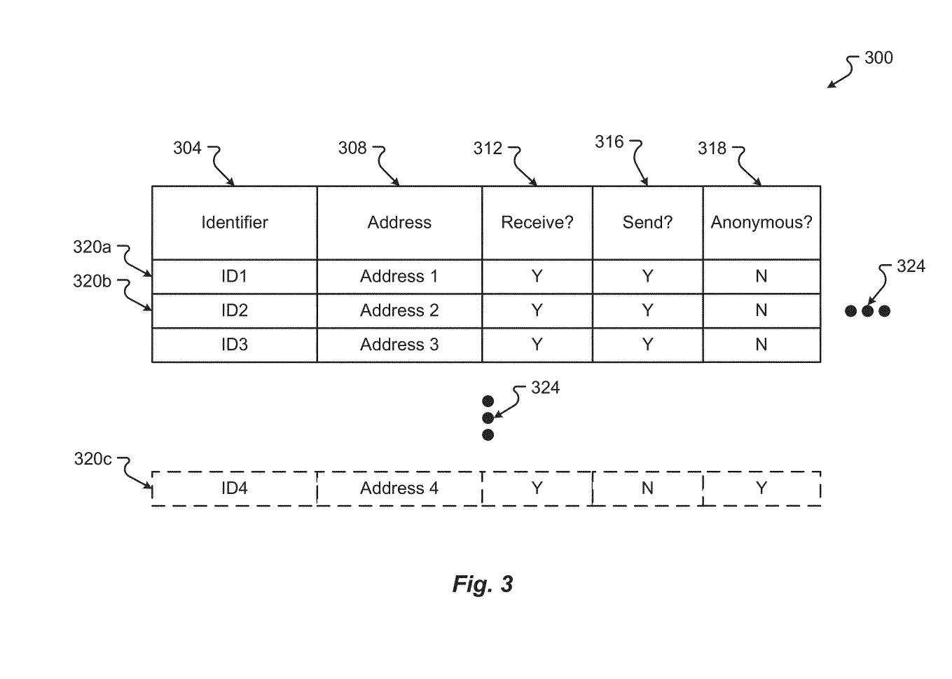

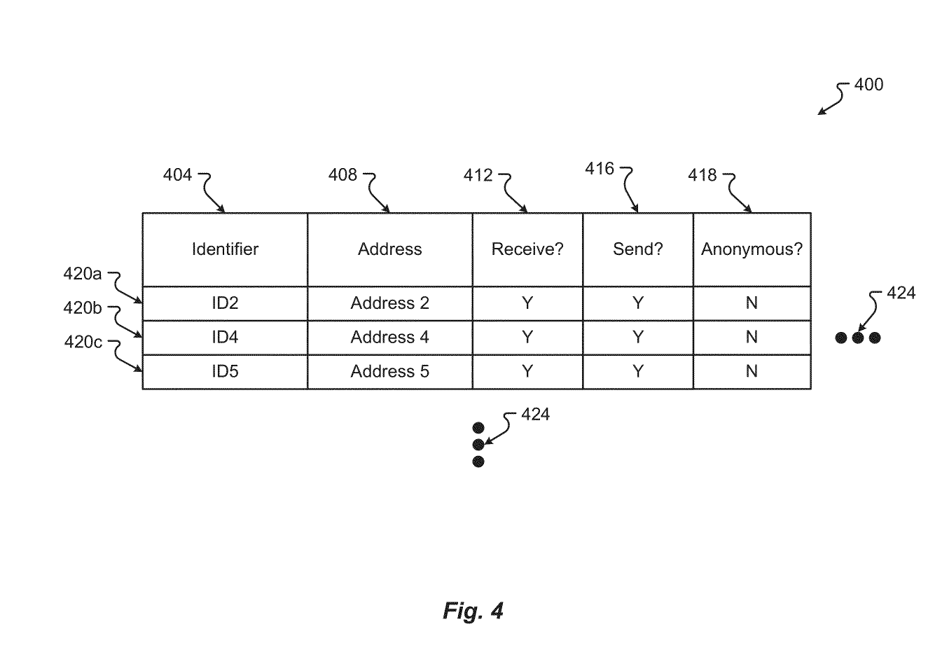

A system 224 of modules 226 executed by or included with the server 120 to conduct the chat session or the side chat session may be as shown in FIG. 2B. Here, the server module 120 may also include a chat module 204, registration module 208, and/or a side chat module 212. These modules 204-212 may be similar to and/or function similar to those described in conjunction with FIG. 2A, and thus, the description in FIG. 2A applies equally to the modules 204-212 of the server 120. Further, the server 120 may include a chat session datastore 228 (which may be the same or similar to datastore 124) that can include information, data, and/or metadata about chat sessions or side chat sessions being conducted by the server 120 and/or associated with one or more devices 108. Embodiments or examples of the information that may be stored in the chat session datastore 224 and/or the datastore 220 may be as described in conjunction with and shown in FIGS. 3, 4, and/or 5.

An embodiment of a data structure 300 that might be stored by a device 108 and/or the server 120 for conducting a chat session may be as shown in FIG. 3. The data structure 300 can have one or more portions, which may be object characteristics, fields or other parts of the stored data depending on the type of datastore or database utilized by the devices 108 and/or the server 120 as described herein. The portions may include, for example, identifiers 304, addresses 308, receive indicators 312, send indicators 316, anonymous indicators 318, etc.

Each of these different categories of information may be associated with a device 108. Each device 108 can have a separate set of data, which is represented by and associated with each one of the rows 320A through 320C. Thus, when a server 120 creates a chat session, that chat session may have data for each of the devices 108a through 108c (and possibly devices 108e and 108d) listed in the different rows or portions. For example, device 108b may have identifier 304 shown in row 320a.

The identifier 304 can be a globally unique identifier (GUID), a phone number, or some other type of identifier that uniquely identifies that device 108 (e.g., 108b) in relation to the other devices 108 (e.g., 108a and 108c). Further, the device 108 may have data associated with an address 308. The address 308 can be any type of address, such as, an IP address, a phone number, or other type of address used to send chat messages or other information to the device 108. The receive indicator 312 can be any indicator (e.g., a flag, logic value, etc.) that indicates whether the device 108 is to receive all the messages from the chat session. Further, the device in row 320A may have a send indicator 316, which can be any indicator (e.g., a flag, logic value, etc.) that indicates whether the device 108 may send messages within the chat session. There may be more portions, fields, and device data (in rows 320) than those shown in the data structure 300, as indicated by ellipses 324.

A device 108 associated with row 320C may be part of a side chat session. Here, the device 108 may be listed as part of a chat session, but may be only have a receive indicator 312 and no send indicator 316. In this situation, the device 108 associated with row 320C that may not have a send indicator 316 may not send messages in the chat session.

Further, the server 120 and/or device 108 may recognize that any device 108 without full permissions, such as the device 108 associated with rows 320c, may be kept anonymous. However, in other configurations, an anonymous indicator 318 (similar to the send or receive indicators 316, 312) may indicate if the device 108 is to be kept anonymous. Further, there may be included with the anonymous indicator 318, one or more identifiers 304 that identify which other devices 108 the present device 108 is to be hidden.

A data structure 400 for establishing or managing a side chat session may be as shown in FIG. 4. The data structure 400 may have the same or similar fields 404-420 to those described in conjunction with FIG. 3, fields 304-320. Thus, the description of fields 304-320 applies equally to the fields 404-420 shown in FIG. 4. The data structure 400 may be associated with a side chat that is associated with a chat session represented by data structure 300.

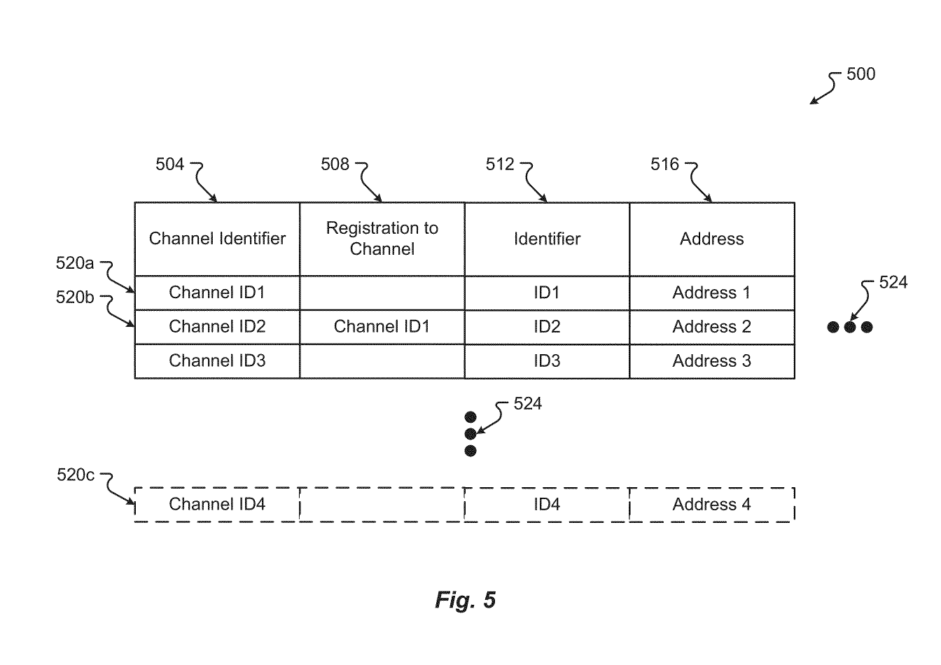

An embodiment of additional data structure 500, or an addition to the data structures 300 and/or 400 shown in FIGS. 3 and/or 4, is shown in FIG. 5 and may present information about channels used in the chat session or side chat session. In some circumstances, the data structure 500 may have portions for a channel identifier 504, a registration portion 508, an identifier portion 512, and an address portion 516. Each row 520 may be associated with a device 108 coupling (a pairing and/or an association of two or more devices in a chat session) and/or a channel 116, 112. There may be more or fewer portions than those shown in FIG. 5, as represented by ellipses 524.

The channel identifier 504 can be any type of identifier such as a GUID or other type of identifier used by the communication network or any other identifier that uniquely identifies that channel of communication between a device 108 and one or more other devices 108 in comparison to other channels used in the chat session or other chat session. A channel, represented by row 520, can register with, and thus, include a registration 508 for, another channel. For example, channel 116a may be registered with channel 112a to receive messages from a first chat session into the side chat session, as described in conjunction with FIG. 1. Thus, channel 116a, identified in row 520B, may have a registration in portion 508 to channel 112a, which is identified in row 520A. The registration information or arrangement of data in the data structure 500 allows the channel 116a to register with a chat session to receive messages but, since the channel 116a does not create messages, will not be sending messages through channel 112a into the first chat session.

Each channel 520 may further have one or more devices 108 associated therewith. The devices 108 associated with the channels 112, 116 can be listed by identifiers 512 and/or addresses 516, which may be the same or similar to identifiers 304, 404 and addresses 308, 408. Thus, no further description is required for portions 512 and 516.

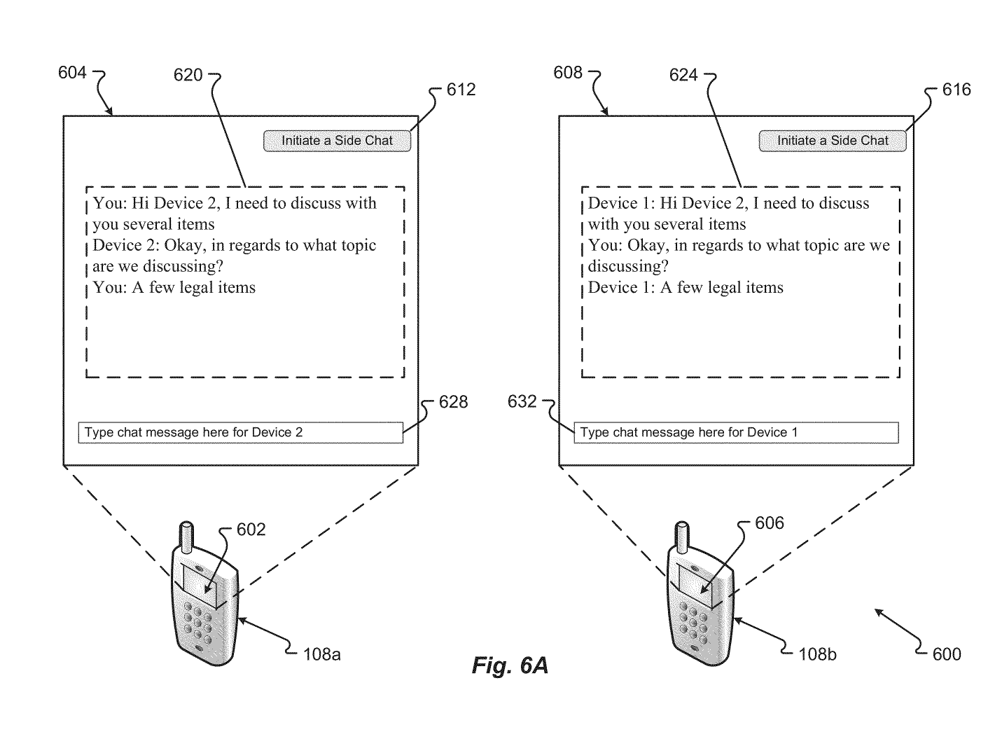

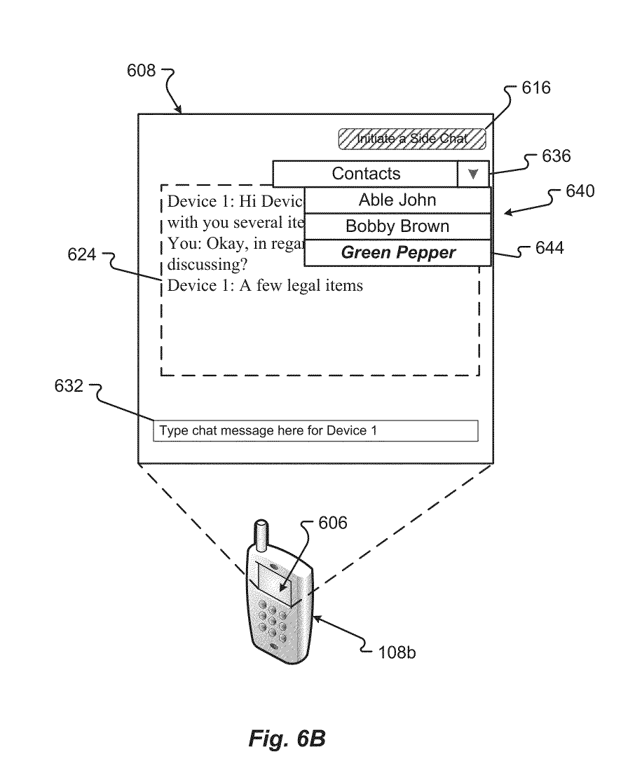

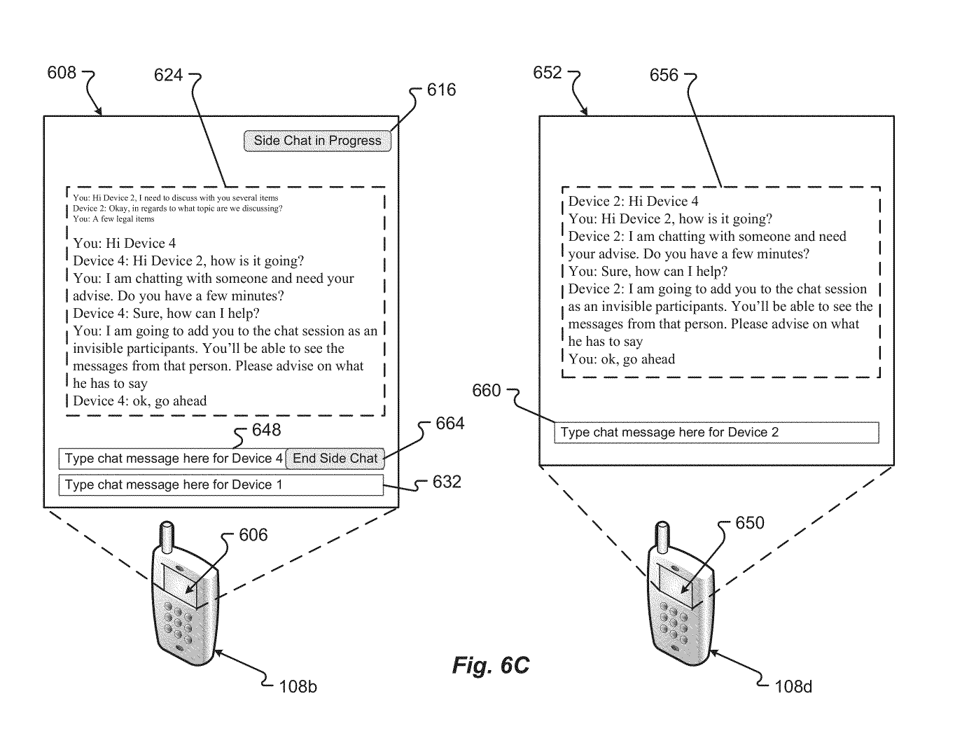

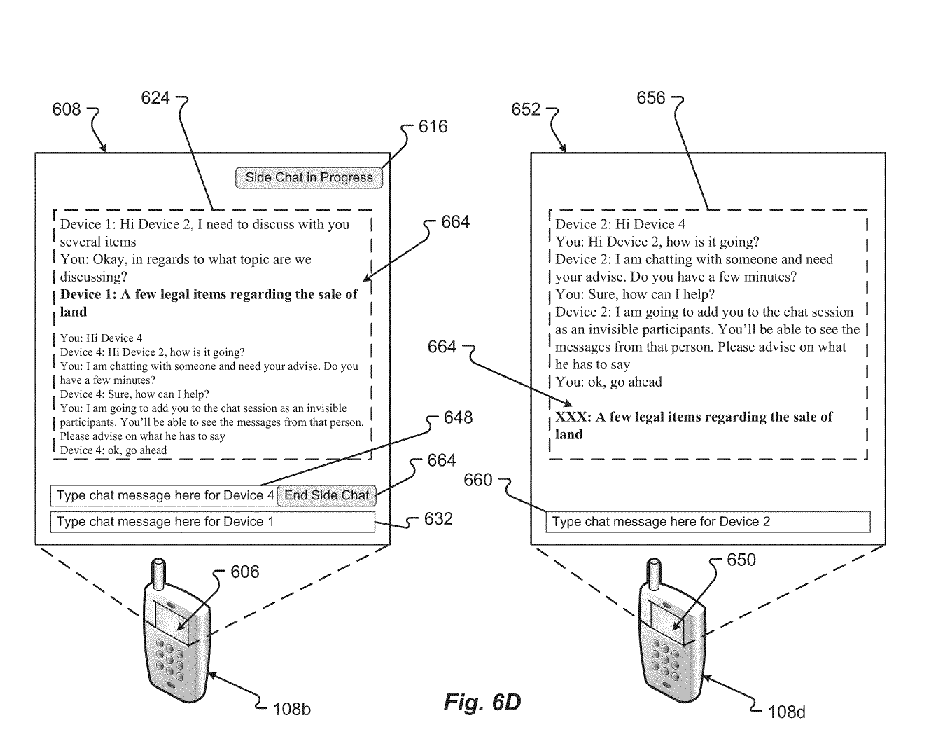

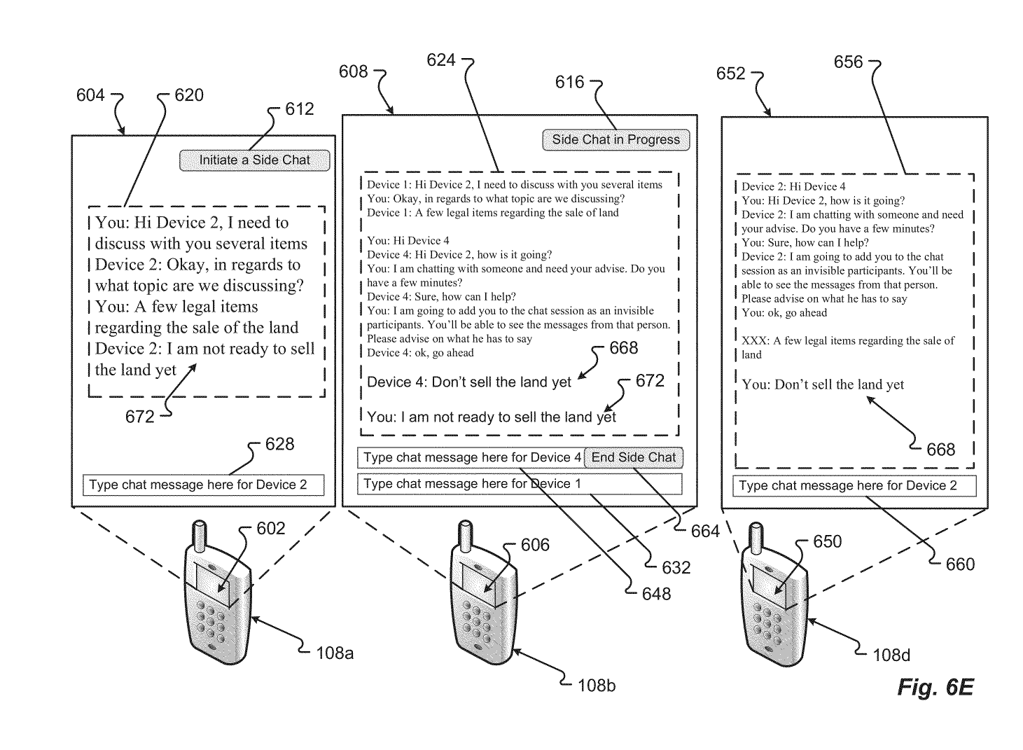

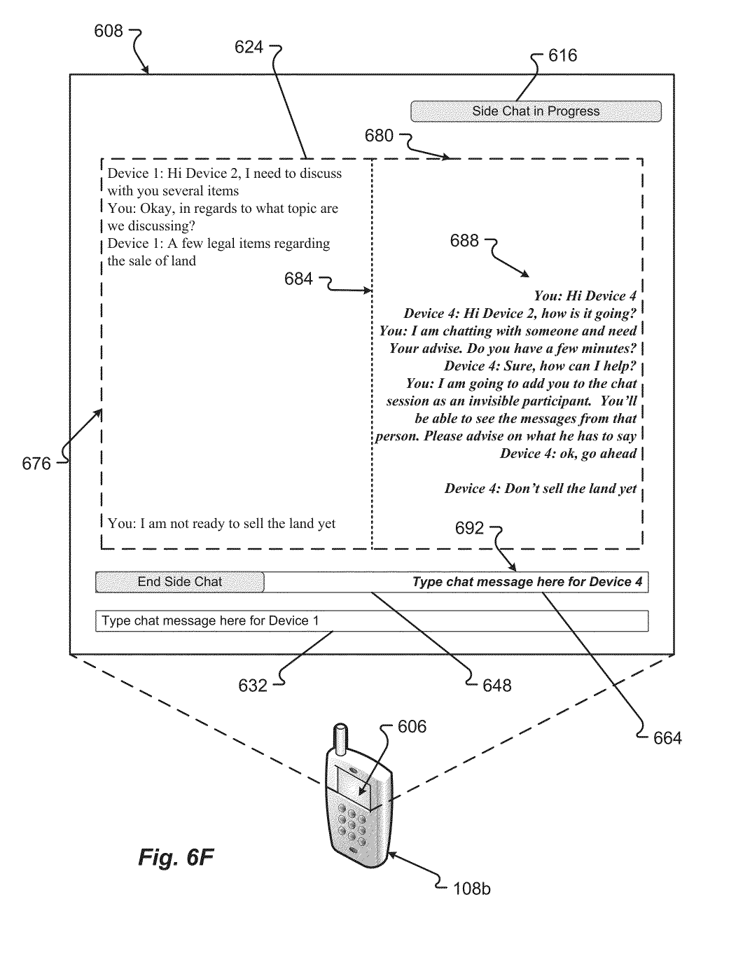

FIGS. 6A-6E show a series of user interfaces that visually demonstrate an example of adding an anonymous participant to a chat session by establishing a side chat session. The systems and methods described herein, can add an anonymous participant to a chat or Instant Messaging (IM) session. Online chat sessions and instant messaging differ from other technologies, such as email, as the communications occur in real time. In other words, messages are exchanged with little delay (e.g., within seconds or minutes) and in a conversational manner.

FIG. 6A shows an environment 600 having two users operating a first device (Device 1) 108a and a second device (Device 2) 108b in an IM chat session. Device 1 executes a first IM client using the chat module 204. The first IM client produces a user interface 604 rendered by the user interface module 216. A second IM client is executed, by device 108b, and produces a second user interface 608. The user interfaces include a user-selectable device 612, 616 (e.g., a button), labeled “Initiate a side chat,” which appears on the IM client user interface 604, 608. Pressing the button “Initiate a side chat” 616, device 2 108b can initiate the process of adding an anonymous participant to the IM session that is already in progress.

Each user interface 604, 608 includes an area or portion 620, 624 that presents or displays one or more messages exchanged in the IM chat session. Further, the user interfaces 604, 608 can also include a text entry area or portion 628, 632 into which a user may type a message to be sent or exchanged in the IM chat session. A further user-selectable device (not shown) may be included with the text entry area 628, 632 to initiate the sending of the message by the user. In other circumstances, the user may initiate the sending of the message through another input, for example, the selection of the return key in a keyboard. The text messages (in an IM chat conversation) already exchanged in the chat session are shown or depicted in portions 620, 624. The chat user interface 604, 608 may be displayed within the entire display area of the device's display 602, 606 or may be displayed in only a portion of the display area.

FIG. 6B shows a change to the user interface 608 after a user of device 108b has selected the “Initiate Side Chat” button. In some instances, the visual appearance of the user-selectable device 616 changes upon selection of the button 616. For example, the shade, color, size, etc. of the button may change to indicate the button has been selected. By pressing the button “Initiate a side chat” 616 Device 2 108b can initiate the process of adding an anonymous participant to the IM session that is already in progress between Device 2 108b and Device 1 108a.

Further, in response to selecting the button 616, the user interface 608 may provide an area for the user to enter the name or identify the device that is to be added in the side chat session. In one configuration, the area may be a drop down menu 636 containing a list 640 of contacts. The contacts may be referred to hereinafter as a “contacts list” or a “buddy list.” Each entry in the buddy list may be selectable to add that person or device to the side chat session. For example, the user of device 2 108b can select entry 644 to add (or invite) “Green Pepper” to a side chat session. Selecting an entry in the contact list 640 can change the visual appearance of the selected entry. For example, by selecting Green Pepper, the entry or user-selectable device 644 is changed such that the font used is italicized and/or bolded. By selecting the entry 644, the side chat module 212 will attempt to add deice 4, associated with the entry “Green Pepper” to a side chat session but keep the addition anonymous from device 1 108a.

FIG. 6C shows another change to the user interfaces of the devices 108b and/or 108d involved in the side chat session. In FIG. 6C, the side chat session between device 108b and 108d has been established. The user interface 650 of device 108d is displaying a window 652 for an IM chat client. The window 652 includes a portion 656 displaying messages from the original chat session established between device 108a and device 108b and message exchanged in the side chat session between device 108b and device 108d. The window 652 can also include a text entry area 660 for the user to enter a message to be sent to device 108b in the side chat session.

The window 608 of device 2 108b has also been changed. For example, the button 616 has be modified to state “Side Chat in Progress” providing device 2 108b with a visual indicia that the user is engaged in both the original chat session and a side chat session. Further, the window 608 can also include a second text entry area 648 where the user can enter a message to be sent to the device 108d in the side chat session. The message for the side chat session can be entered and sent in a similar process as that described above. The window 608 and/or the text entry area 648 can also include another user-selectable device 664 for discontinuing the side chat session. If the user selects the device 664, the side chat session between device 2 108b and device 108d will be discontinued.

Text messages between Device 2 108b and Device 1 108a are depicted by portion 624 along with messages exchanged between Device 2 108b and Device 4 108d. Thus, device 2 108b can view messages from both the original chat session and the side chat session.

FIG. 6D shows a further set of user interfaces depicting how the side chat session may be conducted. The user of device 2 108b may selectively provide device 4 108d content. For example, the user of device 2 108b may select a message 664 (shown in bold) from the original chat session. By providing another user input or simply by selecting the message 664, the selected message 664 can be “copied” or forwarded to device 4 108d. Device 1 108a may only share this selected message in the side chat. As shown in portion 656 of device 4 108d, the selected message 664 may be provided in the window 652. It should be noted that the identity of the sender of the original message (device 1 108a) may be obscured or withheld from device 4 108d, as indicated by the “XXX” in the sender field of the message 664 shown in portion 656. In this way, the user of device 1 108a is unknown to or kept from device 4 108d.

FIG. 6E shows yet another change to the user interfaces 602, 606, and/or 650 showing ongoing messages exchanged in the original chat session and the side chat session. As shown in FIG. 6E, device 4 108d has typed a message in his IM client window 652, in response to message 664. The response 668 is shown in the window 652 and the window 608. However, response 668 is not provided or received by device 1 108a in window 604.

Device 2 108b has then typed a message 672 for device 1 108a in the IM client text entry field 632, which is sent and displayed in window 608. This message is received by device 1 108a and shown in window 604. However, this message 672 may or may not be provided to device 4 108d. In the scenario shown in FIG. 6E, the message 672 is not provided because the user of device 2 108b has not highlighted that message 672 for device 4 108d. Thus we see that the side chat has enabled device 2 108b to seek advice from device 4 108d by anonymously sharing a message from device 1 108a with device 4 108d.

FIG. 6F provides several examples of user interface configurations that may be used to provide a display of the messages exchanged in the original chat session and/or the side chat session. The window 608 provides visual indicia that allow a user to delineate which messages are associated with the original chat session and which messages are associated with the side chat session. On smaller devices, such as smart phones, phablets, tablets, etc., the display area may not be large enough to display two separate windows for the original chat session and the side chat session. Thus, the visual indicia is needed to allow all the messages to be displayed in a single window 608 but allow the user to determine the association or context of the messages.

The window 608 can include the portion 624 to display the messages. However, the portion 624 may be partitioned into a first portion 676 and a second partition 680. The portions 676, 680 may be separated by a visual indicia, for example, dotted line 684. Messages in the first portion 676 may be associated with the original chat session. Messages in the second portion 680 may be associated with the side chat session. Each portion 676, 680 may have a label to indicate which of the chat sessions the portion 676, 680 is associated. In other configurations, other visual indicia may delineate the differences between the portions 676, 680, including a background graphic, a shading of the portion, a dynamic user interface element, etc.

Other visual indicia may be included or used to differentiate the association of the messages. For example, as shown in FIG. 6F, the text of messages 688 for the side chat session can have a different font, color, may have text that is bold, italicized, underlined, highlighted, etc., may have text with a different justification, size, etc. Thus, the actual appearance, arrangement, etc. of the text for the side chat session may be different from the text or messages of the original chat session. Other visual indicia are also possible for the messages, the window 608, the portions 676, 680, etc. to differentiate to which chat session the messages are associated.

To further instruct the user as to which text entry area 632, 648 the user should use to input a message for the original chat session or the side chat session, the text entry areas 632, 648 can also have applied some visual indicia. In some configurations, the visual indicia mimics that used with the portions 676, 680. For example, the text entry area 648 is right justified, italicized, and bolded similar to the messages in portion 680. By mimicking the visual indicia, the user can quickly discern that the text entry area 648 is used to send messages in the side chat session. Other visual indicia may be mimicked or may be used in the text entry areas 676, 680.

It should be noted that the configurations of the user interface can change based on the orientation of the device. For example, when a device is in a landscape orientation, where the horizontal dimension of the display is longer than the vertical dimension, the user may be presented with a split window (two panes in a single window each containing messages from a different chat session), such as that shown in FIG. 6F. However, in a portrait mode, where the horizontal dimension of the display is shorter than the vertical dimension, the user may be presented with a single window, such as that shown in FIGS. 6A-E. Other arrangements, layouts, or visual indicia and appearances may also change based on the device orientation.

In still another configuration, the device 108 may render two or more windows or “pop-up” windows on the user interface 504. The two or more windows may be “stacked” such that one window overlays the other windows and obstructs or obscures the view of the underlying windows. The user may then navigate between the windows using a gesture or by manipulating a user-selectable device displayed on the windows or by interacting with a hardware button or key. In this way, the separate windows are afforded the largest amount of display space in the user interface. In other configurations, the separate windows may be displayed in different parts of the user interface, e.g., in a side-by-side configuration.

Before embodiments of the modules or flow charts are described in detail, it should be noted that the embodiments are not limited to any particular software language and/or hardware/software configurations described or implied in the figures and that a variety of alternative software languages and/or hardware/software configurations may be used for implementation of the embodiments.

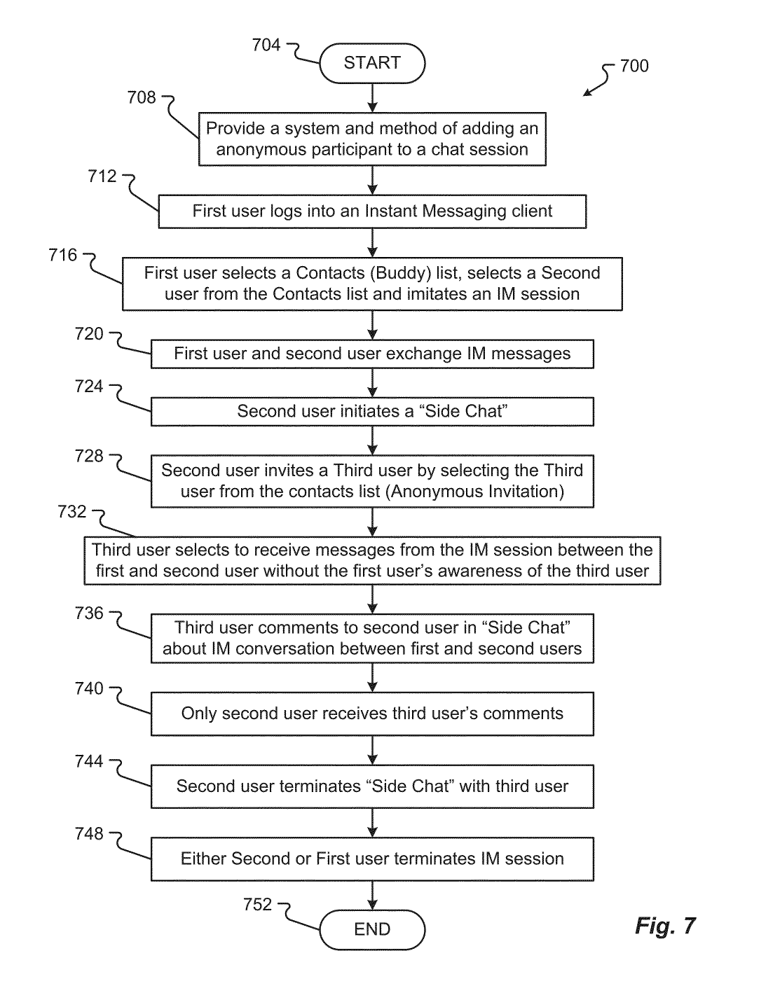

A method 700 for conducting a side chat, by one or more device(s), while conducting a first chat session is shown in FIG. 7. While a general order for the steps of the method 700 is shown in FIG. 7, generally, the method 700 starts with a start operation 704 and ends with an end operation 752. The method 700 can include more or fewer steps or can arrange the order of the steps differently than those shown in FIG. 7. The method 700 can be executed as a set of computer-executable instructions, executed by a computer system, and encoded or stored on a computer readable medium. Further, the method 700 can be executed by a gate or other hardware device or component in an Application Specific Integrated Circuit (ASIC), a Field Programmable Gate Array (FPGA), or other type of hardware device. Hereinafter, the method 700 shall be explained with reference to the systems, components, modules, software, data structures, user interfaces, etc. described herein.

A chat environment 100 may be provided to two or more devices 108, where the users of the two or more devices may conduct an IM session and add an anonymous participant in a side chat session, in step 708. In the environment, a first user logs into IM client, on a device 108, through a chat module 204, in step 712. A user may need to sign up with an IM service provider, for example, with server 120. Signing up to a chat service or system is well known in the art and may require a user to provide their credentials e.g. a user name and a password. The IM service provider, e.g., server 120, then creates a unique user ID for the user. The unique user ID 304 is provided to (by the server 120) or generated by each user so that each user can be identified uniquely in the chat environment. Further, the devices 108 and/or the server 120 can use the user ID 304 or an address 308 to route chat messages and/or other notifications as per their preferences define. The server 120 and/or each user may have one or more default settings. A user may opt to accept the default settings or may opt to modify the setting to personalize the device 108 to suit their needs for the chat session, e.g., a user may define their presence and availability preferences.

A first user may access a contact list (e.g., a Buddy List) to select a second user using a second device 108b, in step 716. Selecting the second device 108b can initiate an IM session, between the first device 108a and the second device 108b, through the server 120. In another configuration, the user selects another user-selectable device after selecting the second user to initiate the IM session. The server 120 may then establish a chat room and register a channel 112b to the first device 108a and a second channel 112a to the second device 108b. The channels may be registered with the chat room in a data structure as described in conjunction with FIGS. 3 through 5.

The first user and the second user can start exchanging IM messages 104, in step 720. IM messages may be composed of text, emoticons, data files, pictures, and/or may also establish a voice or a video session, where the two users can have a voice or a video chat in addition to exchanging text based messages. When an IM message is received by the server 120 at the chat room, the server 120 may forward the IM message to the other device via the associated channel.

The second user may then initiate a side chat, in step 724. For example, the user may select a user-selectable device 616 to initiate the side chat session. The side chat module 212 may receive a signal indicating the selection from the user interface 216. The side chat module may then initiate the creation of any data structure 300, 400, 500, as described in conjunction with FIGS. 3 through 5. Further, the side chat module may provide contact information from, retrieved from a contacts datastore 220, to the user interface 216 to render a contact list 636 for selection, as described in conjunction with FIG. 6B.

The second may be presented the contacts (e.g., the buddy list) 636 in the user interface 606. The second user may then signal to invite a third user to join the side chat, by selecting the contact entry, in step 728. The side chat module 212 and/or registration module 208 may then populate the data structures described in conjunction with FIGS. 3 through 5 with information associated with the third user. Further, the side chat module 212 can send an invitation to the third user to join the side chat. The invitation to the third user and the creation of the side chat may occur without the knowledge of the first user.

In some configurations, the side chat module 212 may determine if the third user can be added to a side chat session. For example, the side chat module 212 may request location information from the device of the third user. Further, the second user may determine the location of the second user and/or the first user. The location information could include Global Positioning Satellite (GPS) coordinates, from a device's GPS receiver or components, or some other type of location information. Upon receiving the location of the third user and/or the second and first user, the side chat module 212 may access a datastore, either local to the device or in communication with the device over a network, to determine a legal jurisdiction for each of the users. From the jurisdiction determination, the side chat module 212 may determine if adding the third user would violate any wire-tapping law or other privacy law that would make the side chat session illegal. If the side chat module 212 does make such a determination, the side chat request may be denied and an error message presented to the second user on the user interface of the device.

The third user may then join the side chat session by accepting the invitation. The side chat module 212 may then create a communication channel 116a between the second device 108b and the fourth device 108d. Both devices 108a and 108d may register with the channel 116a to exchange messages is the side chat. The first user 108a would not be aware of the existence of the channel 116a. Thus, the third user is added to the side chat IM conversation without the first user being aware of the third user. In one configuration, the third user can decide to receive IM messages being exchanged between the first user and the second user, in step 732. In another configuration, the second user may decide which messages, from the IM session between the first user and the second user, the third user will receive. In still another configuration, the first user may have a setting to determine which messages will be shared, although the first user will be unaware that the message are being shared.

In any of the configurations, the identity of the first user may be obscured or “anonymized” when messages, from the first user, are sent to the third user device 108d. Anonymization is the process of either encrypting or removing personally identifiable information from data sets, so that the people viewing the data cannot discern the identity of the person or device providing the message. Anonymizing can include removing the screen name, e-mail address, presence, and other identifying information in conjunction with any other data held either by the second user or disclosed to the first user. Thus, in addition to the first user being unaware of the participation of the third user in the side chat session, the third user may be unaware of the identity of the first user.

The third user can comment, in the side chat session, about the IM conversation between the first user and the second user, in step 736. Thus, the third user may enter a message in text entry area 660 of user interface 650 of the fourth device 108d. The side chat module 212 of device 4 108d may then send the message to device 2 108b over the data channel 116a. However, device 4 108d does not send the message to device 1 108a.

As device 2 108b is registered with the data channel 116a, the second user receives the message sent by device 4 108d. However, neither device 1 108a nor the original chat room/chat session is registered with the data channel 116a and does not receive the message. Further, the second device 108b does not forward the messages from the third user to the first user's device 108a. Thus, the third user's responses are only visible to the second user in user interface 608, in step 740.

As some time thereinafter, the second user can terminate the side chat with the third user, in step 744. For example, the second user can terminate the side chant session by selecting user-selectable device 664. Selecting device 664 can signal the side chat module 212 to end the side chat session. The side chat module 212 of device 108b can send a termination signal to device 4 108d to signal the termination. Also, side chat module 212 may delete or empty any data structure associated with the side chat session and dismantle channel 116a. The original chat session may remain in progress. In some scenarios, the side chat session need not be terminated before the original chat session. The original chat session may be terminated first and the side chat session may remain in progress.

The first user or second user may terminate the original chat session, in step 748. The termination of the original IM chat session may require the first user or second user selecting a user-selectable device (e.g., clicking on a button displayed in the IM client) or the first user or second user closing the IM client in their device 108. Either action can cause the devices 108 to signal each other and/or the server 120 to end the chat session. The devices 108 and/or the server may delete or empty any data structures associated with the chat session and dismantle any communication channels 112 associated with the chat session.

Herein, the IM or chat session may be established between end devices 108 using technologies like WebRTC, which include the fundamental building blocks for communications on the web, such as network, audio, and video components used in voice and video chat applications. These WebRTC components, when implemented in an Internet browser executed by a processor on a device 108, allow access to the camera and microphone, enables sets up of audio and video calls, and allows web browsers to share data via peer-to-peer communications.

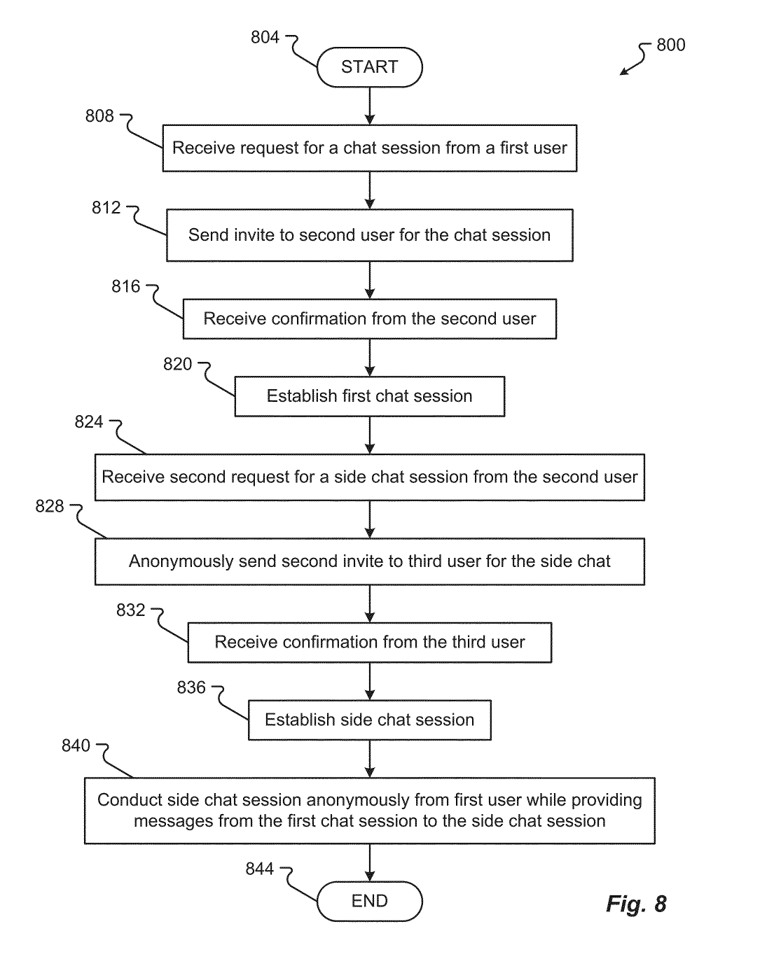

A method 800 for a sever 120 to conduct a side chat, between two or more device(s), while conducting a first chat session is shown in FIG. 8. While a general order for the steps of the method 800 is shown in FIG. 8, generally, the method 800 starts with a start operation 804 and ends with an end operation 844. The method 800 can include more or fewer steps or can arrange the order of the steps differently than those shown in FIG. 8. The method 800 can be executed as a set of computer-executable instructions, executed by a computer system, and encoded or stored on a computer readable medium. Further, the method 800 can be executed by a gate or other hardware device or component in an Application Specific Integrated Circuit (ASIC), a Field Programmable Gate Array (FPGA), or other type of hardware device. Hereinafter, the method 800 shall be explained with reference to the systems, components, modules, software, data structures, user interfaces, etc. described herein.

A first user, on a device 108a, can initiate an IM session, between the first device 108a and the second device 108b, through the server 120. The server 120 can receive a request message, to initiate the IM chat session, from the device 108a, in step 808. In response to the request message, which can include any information necessary to invite the second device 108b and/or initiate a chat room session, the server 120 can send an invite to the second device 108b, in step 812. The server 120 can then receive an acceptance or confirmation of the invitation from device 108b, in step 816. The confirmation may include information from device 108b to initiate the chat session.

The server 120 may then establish a chat room and register a channel 112b to the first device 108a and a second channel 112a to the second device 108b to begin the chat session, in step 820. The channels 112 may be registered with the chat room in a data structure as described in conjunction with FIGS. 3 through 5. The first user and the second user can start exchanging IM messages 104 through the chat room, where the server 120 can copy or duplicate messages between the channels 112a and 112b. IM messages may be composed of text, emoticons, data files, pictures, and/or may also establish a voice or a video session, where the two users can have a voice or a video chat in addition to exchanging text based messages. When an IM message is received by the server 120 at the chat room, the server 120 may forward the IM message to the other device 108 via the associated channel 112.

The second user may then initiate a side chat that includes sending a side chat request to the server 120, in step 824. For example, the user may select a user-selectable device 616 to initiate the side chat session. The side chat module 212 may receive a signal indicating the selection from the user interface 216. The side chat module may then request a side chat session from the side chat module 212 at the server 120. The side chat module 212 at the server may send an invitation, without the knowledge of the first device 108a, to another device 108e, in step 828. As explained above with step 724, the side chat module 212 of the server 120 may also determine if there are any legal barriers to the side chat session.

The side chat module 212 of the server 120 may then receive a confirmation or acceptance of the invitation from the other device 108e, in step 832. In response to receiving the confirmation, the side chat module 212 of the server 120 may establish the side chat session, in step 836. To establish the side chat session, the side chat module 212 of the server 120 can initiate the creation of any data structure 300, 400, 500, as described in conjunction with FIGS. 3 through 5. Further, the side chat module 212 of the server 120 may establish new communications channels 116b and/or 116c between devices 108b and 108e. Both devices 108b and 108e may register with the channel(s) 116b and/or 116e to exchange messages in the side chat. The first user 108a would not be aware of the existence of the channel 116b and/or 116e. Thus, the third user is added to the side chat IM conversation without the first user being aware of the third user. In one configuration, the third user can decide to receive IM messages being exchanged between the first user and the second user, in step 840. In another configuration, the second user may decide which messages, from the IM session between the first user and the second user, the third user will receive. In still another configuration, the first user may have a setting to determine which messages will be shared, although the first user will be unaware that the message are being shared.

In any of the configurations, the identity of the first user may be obscured or “anonymized” when messages, from the first user, are sent to the third user device 108d. Anonymization is the process of either encrypting or removing personally identifiable information from data sets, so that the people viewing the data cannot discern the identity of the person or device providing the message. Anonymizing can include removing the screen name, e-mail address, presence, and other identifying information in conjunction with any other data held either by the second user or disclosed to the first user. Thus, in addition to the first user being unaware of the participation of the third user in the side chat session, the third user may be unaware of the identity of the first user.

The third user can comment, in the side chat session, about the IM conversation between the first user and the second user. Thus, the third user may enter a message in text entry area 660 of user interface 650 of the device 108e. The side chat module 212 of device 5 108e may then send the message to device 2 108b over the data channels 112b and 116b or 116e. However, device 5 108e does not send the message to device 1 108a.

As device 5 108e is registered with the data channel 116b and/or 116e, the other user receives the message sent by device 2 108b. However, device 1 108a is registered with the data channel 116b or 116e and does not receive the message. Further, the second device 108b does not forward the messages from the third user to the first user's device 108a. Thus, the third user's responses are only visible to the second user in user interface 608.

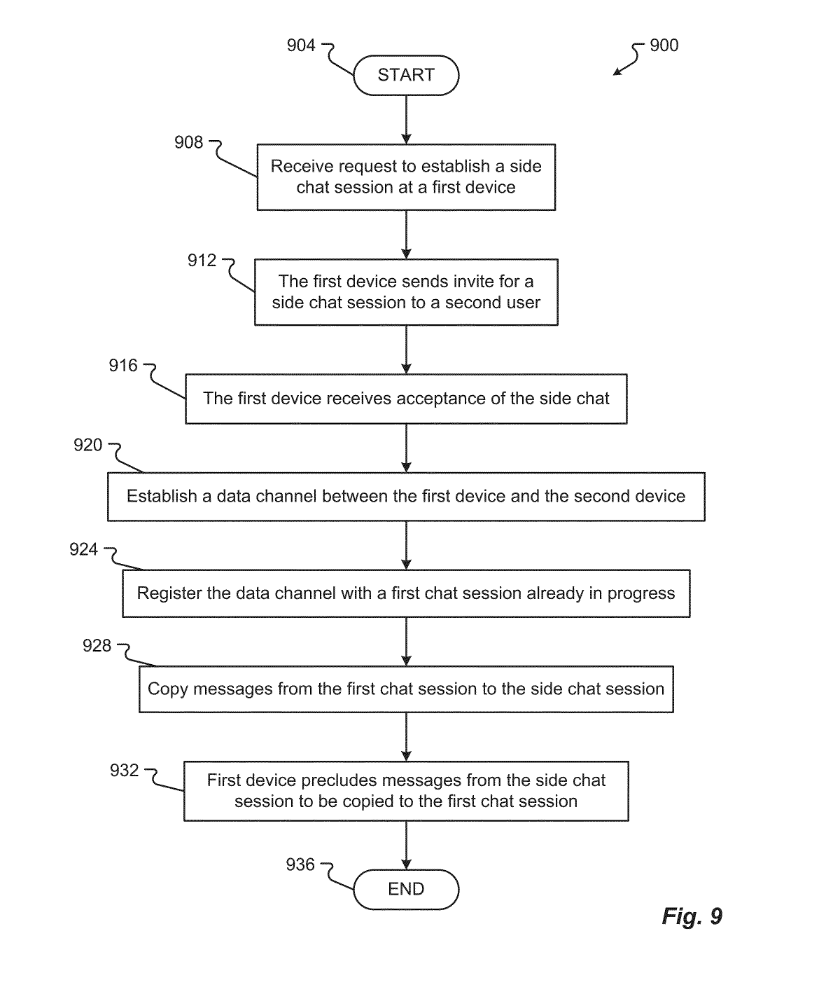

An embodiment of a method 900 for establishing the side chat session through a communication channel is shown in FIG. 9. While a general order for the steps of the method 900 is shown in FIG. 9, generally, the method 900 starts with a start operation 904 and ends with an end operation 936. The method 900 can include more or fewer steps or can arrange the order of the steps differently than those shown in FIG. 9. The method 900 can be executed as a set of computer-executable instructions, executed by a computer system, and encoded or stored on a computer readable medium. Further, the method 900 can be executed by a gate or other hardware device or component in an Application Specific Integrated Circuit (ASIC), a Field Programmable Gate Array (FPGA), or other type of hardware device. Hereinafter, the method 900 shall be explained with reference to the systems, components, modules, software, data structures, user interfaces, etc. described herein.

A chat environment 100 may be provided to two or more devices 108, where the users of the two or more devices may conduct an IM session and add an anonymous participant in a side chat session. In the environment, a first user logs into IM client, on a device 108a, through a chat module 204. A first user may access a contact list (e.g., a Buddy List) to select a second user using a second device 108b. Selecting the second device 108b can initiate an IM session, between the first device 108a and the second device 108b, through the server 120. In another configuration, the user selects another user-selectable device after selecting the second user to initiate the IM session. The server 120 may then establish a chat room and register a channel 112b to the first device 108a and a second channel 112a to the second device 108b. The channels may be registered with the chat room in a data structure as described in conjunction with FIGS. 3 through 5.

The first user and the second user can start exchanging IM messages 104. IM messages may be composed of text, emoticons, data files, pictures, and/or may also establish a voice or a video session, where the two users can have a voice or a video chat in addition to exchanging text based messages. When an IM message is received by the server 120 at the chat room, the server 120 may forward the IM message to the other device via the associated channel.

The second user may then initiate a side chat, in step 908. For example, the user may select a user-selectable device 616 to initiate the side chat session. The side chat module 212 may receive a signal, from the user interface 216, indicating a request to establish side chat session. The side chat module 212 may then initiate the creation of any data structure 300, 400, and 500, as described in conjunction with FIGS. 3 through 5. Further, the side chat module 212 may provide contact information from, retrieved from a contacts datastore 220, to the user interface 216 to render a contact list 636 for selection, as described in conjunction with FIG. 6B.

The second user may be presented the contacts (e.g., the buddy list) 636 in the user interface 606. The second user may then signal to invite a third user to join the side chat, by selecting the contact entry. The side chat module 212 and/or registration module 208 may then populate the data structures described in conjunction with FIGS. 3 through 5 with information associated with the third user. Further, the side chat module 212 can send an invitation to the third user to join the side chat, in step 912. The invitation to the third user and the creation of the side chat may occur without the knowledge of the first user.

The third user may then join the side chat session by accepting the invitation, which may be received by the side chat module 212 of the second device 108b, in step 916. The side chat module 212 may then create or establish a communication channel 116a between the second device 108b and the fourth device 108d, in step 920. A communication channel 116a can be established using various protocol implementations including, but limited to, published protocol standards for communication such as Session Initiation Protocol (SIP) or the Extensible Messaging and Presence Protocol (XMPP). The communication channels 116a can be established between end point devices 108b and 108d both operated by individual persons, or by an automated entity.

In a chat session, as individuals join to participate in a chat room session, the user's client interfaces (whether from mobile, web, or other application interface) can leverage a communication channel registration approach to send and receive content (instant messages, links, media, etc.) to and from the chat room. The chat room can accept the communication channel connections as automated entities. The chat room element acts as a channel “switch,” which can take content from one user (e.g., device 1 108a), can apply any application logic (e.g., profanity filters, archiving, analytical data, etc.), and can “echo” or copy the content to the remainder of the devices registered to the chat room.

With the introduction of the side chat, the user interface 608 can allow a second user (by selecting user-selectable device 616), while participating in a chat room to initiate another channel of communication 116a to device 108d. The devices 108b and 108d can register with the new data channel 116a, in step 924. The server 120 or the devices 108b, 108d can store the registration information and any other data to establish the side chat channel 116a in data structures, as described in conjunction with FIGS. 3 through 5.

The side chat communication 116a can allow flow through of content from the chat room to device 108d to allow the third user to observe the content, in step 928. However, any content created by the third user can only be observed via the channel 116a by the user of device 108b (the content in channel 116a is not submitted to the chat room). Control and replication of the content between the chat room and device 108d can be controlled by the IM client implementation in use in device 108b. The IM client on device 108b may also prevent any replication or visibility of the content on channel 116a, from device 108d, to the chat room channel 112a, in step 932.

The above configuration may allow the end user full control of the communication channels 116. A user initiating the channel 116 with the other device 108d can exert the control of how messages are communicated over that channel 116. The other device 108d may only have the capability to view or manage the channel 116a of communication initiated with device 108b.

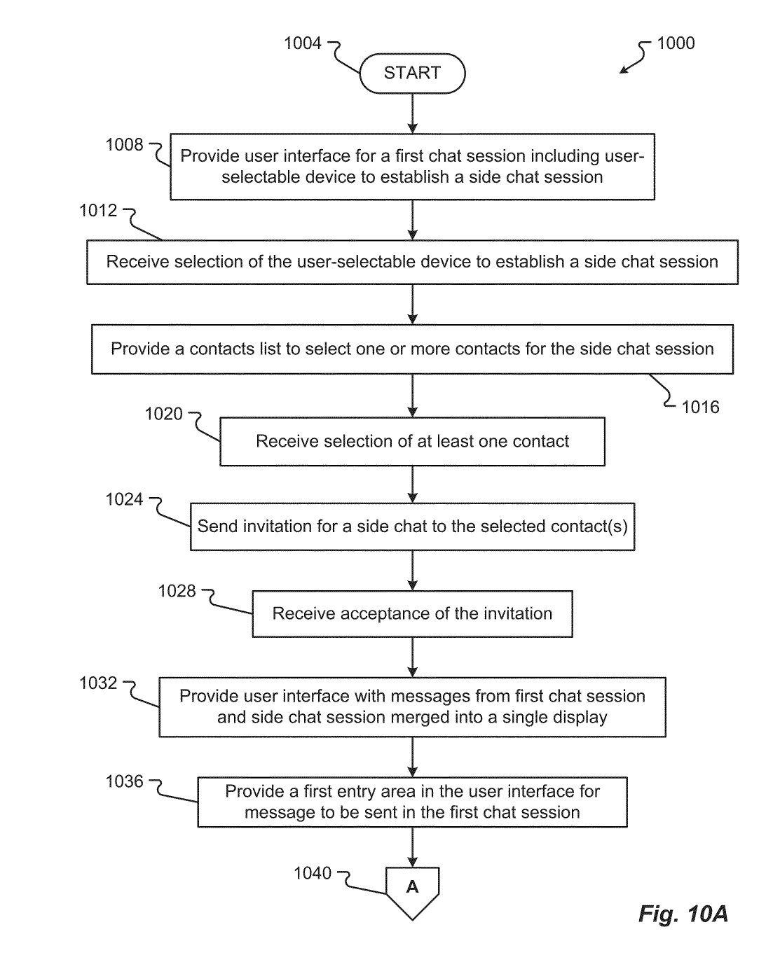

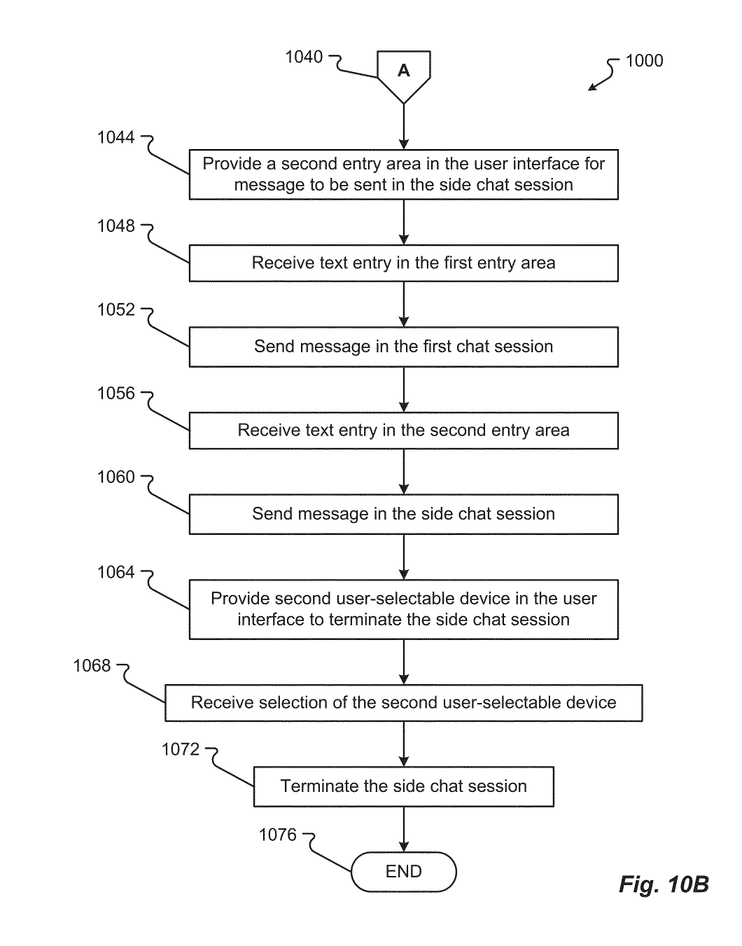

An embodiment of a method 1000 for establishing the side chat session through a communication channel is shown in FIGS. 10A and 10B. While a general order for the steps of the method 1000 is shown in FIG. 10, generally, the method 1000 starts with a start operation 1004 and ends with an end operation 1076. The method 1000 can include more or fewer steps or can arrange the order of the steps differently than those shown in FIG. 10. The method 1000 can be executed as a set of computer-executable instructions, executed by a computer system, and encoded or stored on a computer readable medium. Further, the method 1000 can be executed by a gate or other hardware device or component in an Application Specific Integrated Circuit (ASIC), a Field Programmable Gate Array (FPGA), or other type of hardware device. Hereinafter, the method 1000 shall be explained with reference to the systems, components, modules, software, data structures, user interfaces, etc. described herein.

A chat environment 100 may be provided to two or more devices 108, where the users of the two or more devices may conduct an IM session and add an anonymous participant in a side chat session. In the environment, a first user logs into IM client, on a device 108, by selecting a user-selectable device (e.g., an icon on a desktop of a device). The first user is then provided an initial user interface to begin an IM chat session. The first user may then access a contact list (e.g., a Buddy List) provided on the initial user interface to select a second user using a second device 108b. Selecting the second device 108b can initiate an IM session, between the first device 108a and the second device 108b, through a server 120. In another configuration, the user selects another user-selectable device (e.g., a button), after selecting the second user from the buddy list, to initiate the IM session. The server 120 may then establish a chat room and register a channel 112b to the first device 108a and a second channel 112a to the second device 108b. The channels may be registered with the chat room in a data structure as described in conjunction with FIGS. 3 through 5.

The first user and the second user can start exchanging IM messages 104 in the first chat session, in step 1008, through user interfaces 604 and 608, as described in conjunction with FIG. 6A. The second user may be presented with a user interface 608 for the first chat session with a user-selectable device 616. The user-selectable device 616 may be as described in conjunction with FIG. 6A. The user-selectable device 616 can receive a selection to establish a side chat session, in step 1012. In response to the selection of the user-selectable device 616, the device 108b can provide a contacts list 636, in step 1016, as described in conjunction with and shown in FIG. 6B. Further, the user-selectable device 616 may be modified to indicate the selection of the user-selectable device 616, as described in conjunction with and shown in FIG. 6B.

The contacts list 636 can present the contacts (e.g., the buddy list) 636 in the user interface 606 and allow the user to select an entry 644 from a list of entries 644. The second user may then signal to invite a third user to join the side chat, by selecting the contact entry 644, in step 1020. In response to the selection, the side chat module 212 and/or registration module 208 may then populate the data structures described in conjunction with FIGS. 3 through 5 with information associated with the third user. Further, the side chat module 212 can send an invitation to the third user to join the side chat, in step 1024. The invitation may be displayed on the user interface 650 of device 108d for the third user to accept or decline. If the third user accepts the invitation (by selecting a user-selectable device to confirm the invitation), an acceptance of the invitation can be received by device 108b, in step 1028.

In response to receiving the acceptance, the side chat session may be established between device 108b and device 108d. The user interface 606 of device 108b can be modified, in step 1032, to allow messages from the first chat session and the side chat session to be exchanged in a same window 608, as described in conjunction with and shown in FIG. 6C. Here, the portion 624 of the window 608 may show messages from both the first chat session and the side chat session, as shown in FIG. 6C. The visual indicia associated with the messages may be different, as described in conjunction with and shown in FIG. 6F. The third device 108d may also provide a window 652 for receiving and sending messages in the side chat session.

Further, window 608 can provide, in step 1036, a first text entry area 632 to allow the second user to enter messages for the first chat session, as described in conjunction with and shown in FIG. 6C. The method 1000 can continue to FIG. 10B through connector 1040. In step 1044, window 608 can provide a second text entry area 664 to allow the second user to enter messages for the side chat session, as described in conjunction with and shown in FIG. 6C. In one scenario, the device 108b can receive text entry into text entry area 632, in step 1048. The entered message is sent to the first device 108a in the first chat session, in step 1052. The third device 108d can receive the message, in step 1056. Further, the entered message is shown in portion 624 of window 608. The first device 108a may also show the entered message, once received, in portion 620 of window 604, as described in conjunction with and shown in FIGS. 6A through 6E. The entered message may also be sent to the third device 108d, in step 1060. Thus, portion 656 of window 652 may also show the entered message, as described in conjunction with and shown in FIGS. 6A through 6E.

In another scenario, the device 108b can receive a second text entry into text entry area 648. The second entered message is not sent to the first device 108a in the first chat session. The second entered message is shown in portion 624 of window 608, as described in conjunction with and shown in FIGS. 6A through 6E. Further, the second entered message may be sent to the third device 108d. Thus, portion 656 of window 652 may also show the entered message, as described in conjunction with and shown in FIGS. 6A through 6E.

In still another scenario, the device 108b can receive a selection of text in portion 624. The selected message may be highlighted or have a change in its appearance to indicate the selection. The selected message may be sent to the third device 108d. Thus, portion 656 of window 652 may show the selected message, as described in conjunction with and shown in FIGS. 6A through 6E. However, if the selected message is from the first device 108a, the display of the selected message in window 652 may obscure or change the identity of the first user to “anonymize” the first user from the third user, as described in conjunction with and shown in FIGS. 6A through 6E. It should be noted that the messages that are sent to device 108d may not selected through a copy and paste process. Rather, the second user may simply select messages by highlighting or indicating the message in window 512 and need not complete a “paste” function. Further, it must be noted that while the first and second devices 108a and 108b may be chatting in a public chat room, where the identity of the users is known, those identities can be eliminated or obscured when messages from those users are replicated in the side chat session.

In still further configurations, a second user may pre-select user preferences about which messages to transfer to device 108d after starting the side chat session. One user preference can provide all message previously exchanged between device 108a and 108b to device 108d. In this scenario, the third user is “caught up” in the original chat session. Another user preference may allow only messages selected by the second user in window 512 to be sent to device 108d. A third user preference may provide all messages to the third device 108d after the initiation of the side chat session but preclude any past messages from being sent. Any of these user preference could be a default setting for device 108b. The user may also select the preferences as options when establishing the side chat session rather than pre-select the preferences.

The window 608 can also display a second user-selectable device 664 to terminate the side chat session, in step 1064. The button 664 may receive a selection, in step 1068. In response to receiving the selection, the second device 108b can terminate the side chat session, in step 1072. Terminating the side chat session may include changing the window 608. The second text entry area 648 and the button 664 may be eliminated. The button 616 may change its visual appearance and may change the text to appear as shown in FIG. 6A to state “Initiate a side chat.” Further, the side chat entries shown in portion 624 may be visually changed or deleted. Entries for the first chat session in portion 624 may remain along with the first text entry area 632.

FIG. 11 illustrates a block diagram of a system 1100 that may connect parties in a chat session or a side chat session. The system 1100 includes one or more user computers 1105, 1110, and 1115. The user computers 1105, 1110, and 1115 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 1105, 1110, 1115 may also have any of a variety of applications, including for example, database client and/or server applications, and web browser applications. Alternatively, the user computers 1105, 1110, and 1115 may be any other electronic device, such as a thin-client computer, Internet-enabled mobile telephone, and/or personal digital assistant, capable of communicating via a network (e.g., the network 1120 described below) and/or displaying and navigating web pages or other types of electronic documents. Although the exemplary system 1100 is shown with three user computers, any number of user computers may be supported.

System 1100 further includes a network 1120. The network 1120 may can be any type of network familiar to those skilled in the art that can support data communications using any of a variety of commercially-available protocols, including without limitation TCP/IP, SNA, IPX, AppleTalk, and the like. Merely by way of example, the network 1120 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 1125, 1130. One server may be a web server 1125, which may be used to process requests for web pages or other electronic documents from user computers 1105, 1110, and 1120. The web server can be running an operating system including any of those discussed above, as well as any commercially-available server operating systems. The web server 1125 can also run a variety of server applications, including HTTP servers, FTP servers, CGI servers, database servers, Java servers, and the like. In some instances, the web server 1125 may publish available operations as one or more web services, such as chat sessions.

The system 1100 may also include one or more file and or/application servers 1130, which can, in addition to an operating system, include one or more applications accessible by a client running on one or more of the user computers 1105, 1110, 1115. The server(s) 1130 may be one or more general purpose computers capable of executing programs or scripts in response to the user computers 1105, 1110 and 1115. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 1130 may also include database servers, including without limitation those commercially available from Oracle, Microsoft, Sybase™, IBM™ and the like, which can process requests from database clients running on a user computer 1105.

In some embodiments, an application server 1130 may create web pages dynamically for displaying. The web pages created by the web application server 1130 may be forwarded to a user computer 1105 via a web server 1125. Similarly, the web server 1125 may be able to receive web page requests, web services invocations, and/or input data from a user computer 1105 and can forward the web page requests and/or input data to the web application server 1130.

In further embodiments, the server 1130 may function as a file server. Although for ease of description, FIG. 11 illustrates a separate web server 1125 and file/application server 1130, those skilled in the art will recognize that the functions described with respect to servers 1125, 1130 may be performed by a single server and/or a plurality of specialized servers, depending on implementation-specific needs and parameters.

The system 1100 may also include a database 1135. The database 1135 may reside in a variety of locations. By way of example, database 1135 may reside on a storage medium local to (and/or resident in) one or more of the computers 1105, 1110, 1115, 1125, 1130. Alternatively, it may be remote from any or all of the computers 1105, 1110, 1115, 1125, 1130, and in communication (e.g., via the network 1120) with one or more of these. In a particular set of embodiments, the database 1135 may reside in a storage-area network (“SAN”) familiar to those skilled in the art. Similarly, any necessary files for performing the functions attributed to the computers 1105, 1110, 1115, 1125, 1130 may be stored locally on the respective computer and/or remotely, as appropriate. In one set of embodiments, the database 1135 may be a relational database, such as Oracle 10i™, that is adapted to store, update, and retrieve data in response to SQL-formatted commands.

FIG. 12 illustrates an embodiment of a computer or computing system 1200 upon which a chat session or a side chat session may be conducted or executed. The computer or computer system 1200 can represent any device described or represented herein. The computer system 1200 is shown comprising hardware elements that may be electrically coupled via a bus 1255. The hardware elements may include one or more central processing units (CPUs) 1205; one or more input devices 1210 (e.g., a mouse, a keyboard, etc.); and one or more output devices 1215 (e.g., a display device, a printer, etc.). The computer system 1200 may also include one or more storage device(s) 1220. By way of example, storage device(s) 1220 may be disk drives, optical storage devices, solid-state storage device such as a random access memory (“RAM”) and/or a read-only memory (“ROM”), which can be programmable, flash-updateable and/or the like.

The computer system 1200 may additionally include a computer-readable storage media reader 1225; a communications system 1230 (e.g., a modem, a network card (wireless or wired), an infra-red communication device, etc.); and working memory 1240, which may include RAM and ROM devices as described above. In some embodiments, the computer system 1200 may also include a processing acceleration unit 1235, which can include a DSP, a special-purpose processor and/or the like

The computer-readable storage media reader 1225 can further be connected to a computer-readable storage medium, together (and, optionally, in combination with storage device(s) 1220) comprehensively representing remote, local, fixed, and/or removable storage devices plus storage media for temporarily and/or more permanently containing computer-readable information. The communications system 1230 may permit data to be exchanged with the network 1220 and/or any other computer described above with respect to the system 1200.

The computer system 1200 may also comprise software elements, shown as being currently located within a working memory 1240, including an operating system 1245 and/or other code 1250, such as program code implementing a web service connector or components of a web service connector. It should be appreciated that alternate embodiments of a computer system 1200 may have numerous variations from that described above. For example, customized hardware might also be used and/or particular elements might be implemented in hardware, software (including portable software, such as applets), or both. Further, connection to other computing devices such as network input/output devices may be employed.

A number of variations and modifications of the disclosure can be used. It would be possible to provide for some features of the disclosure without providing others.

For example, an implementation example of the methods 700-1000, described in conjunction with FIGS. 7-10, can involve the use of a translation robot. A first user and second user start an IM session. In the example, a first user initiates a “Side Chat”. Instead of another device with a user, the first user invites or invokes a translation bot to translate messages of the second user received in the initial IM session. The translation bot can be a type of bot that can translate messages from one language to another.

A bot (short for “robot”) or Internet bot, also known as web robot, WWW robot, or simply bot, is a software application that runs automated tasks over the Internet. A bot can operate as an agent for a user or another program or simulates a human activity. Typically, bots perform tasks that are both simple and structurally repetitive, at a much higher rate than would be possible for a human alone. Thus, a bot is most suitable for situations that demand performing highly repetitive operations at a fast speed without requiring human intervention.

The translation bot can selectively receive messages of the second user and translate them to the language of preference of the first user. Further, the first user can send messages to the bot for translation to the language of preference of the second user. Those translated messages may then be sent to the second user in the initial chat session. The translation bot may be directly added from the first user's contact list or buddy list or may be engaged via a third party service.

In another configuration, a translation service, instead of a bot, may be provided by a person. The person providing the translation may be directly added from the first user's contact list or buddy list or may be engaged via a third party service e.g., a company that specializes in translation services.

Another implementation example of the methods 700-1000, described in conjunction with FIGS. 7-10, can involve establishing a management or business discussion forum. The business discussion can have participants and/or observers. The participants can be actively engaged in exchanging IM messages in the chat session. One or more of the active participants can initiate a side chat. For example, the participants can initiate a side chat to keep the observers informed on the business discussion.

The observers may be visible to all participants and can become active participants in the business discussion. However, the observers may also be invisible to or not known by the other participants not involved in the side chat. If an observer is passive and invisible, the observer may not be able to become an active participant in the business discussion.

The above described example may be useful in a business environment where some people are actively engaged in a business discussion and some other people need to be kept informed but are not essentially participating actively in the business discussion.

Messages seen by the Observers can be retained or selected by the participant initiating the side chat. Thus, based on the status or preferences of the participant, messages that can be seen by observers is dependent on which participants are selecting the messages, e.g., highlighting the messages. Therefore only messages highlighted by active participants, who may have initiated the side chat, are seen by certain observers. In another configuration, all of the messages being exchanged between participants are seen by the observers.

The environment may also provide devices to share only select messages with the observers by providing control elements in the IM or chat client of the participants, e.g., by default all messages are hidden until a user-selectable button is pressed by a participant and, once the button is released or deselected, the revealed messages are again hidden from the observers. Alternatively, the messages being exchanged between the participants are visible to the observers for limited period of time, or only in the current IM session, or may depend on other rule sets that may be configurable by a user.

Control over what portions of the IM or chat conversation are visible to the observers may be managed through Graphical User Interface (GUI) control elements, e.g., by providing a button on the IM or chat client or by providing tools for selecting portions of IM or chat messages being exchanged between the participants.

Chat messages provided to an observer on a side chat may be placed in-line with the existing IM or chat interaction. Alternatively, the messages provided to an observer on a side chat may be displayed in a separate user interface area or window.

The IM participant initiating the side chat may have control over the content that is being shared in the IM or chat session. The participant initiating the side chat may retain the rights and selectively grant these rights to the observers to visually interact with the content, e.g., by highlighting or annotating select content without the observers being aware of the highlighting or annotation of the selection.

Other implementation examples of the methods 700-1000, described in conjunction with FIGS. 7-10, can include scenarios as described hereinafter.

A human resources unit of a company is kept informed, in a side chat, when a manager may be warning a subordinate employee of inappropriate behavior.

A couple who are in a divorce proceeding may anonymously include their respective lawyers in a side chat, such that e.g., the wife's lawyer can observe what the husband is saying and can privately comment to the wife on how to reply to the message. Similarly the husband's lawyer may be able to observe and comment on the messages that the wife is sending. A lawyer may be directly added to a side chat from the user's contact list or buddy list or may be engaged via a third party service.

In another example, two business partners in a dispute can include their respective lawyers in separate side chats. The respective lawyer may observe and comment on the other partner's messages. The partners may be anonymized to the lawyer of the other party, i.e., each lawyer only knows the partner who engaged them, but may not know who the other partner is because the other partner's identifying information is obscured or changed.

The systems, devices, components, methods, etc. described herein can emulate the functionality and features of the side chat using existing third party chat or IM clients. Such an approach may be implemented using the existing chat client technologies through their existing extensibility APIs (Application Programming Interface). Where there are limitations on the third party Chat or IM clients such that these Chat or IM clients do not provide interface extensions, the side chat may be implemented through the use of a separate chat or IM window and messages may be “shared” via automated-screenshot type approach.

The IM or chat session may be established using technologies like WebRTC. WebRTC is an open source project that enables web browsers with Real-Time Communications (RTC) capabilities using JavaScript APIs. It includes the fundamental building blocks for communications on the web such as network, audio, and video components used in voice and video chat applications. These components, when implemented in a browser, can be accessed through a Javascript API, enabling developers to implement their own RTC web application. Major components of WebRTC include:
GetUserMedia: allows a web browser to access the camera and microphone
PeerConnection: enables sets up audio/video calls
DataChannels: allows web browsers to share data via peer-to-peer

Embodiments may include parallel real time services along with the text based IM or chat session, for example, including, but not limited to, a voice and/or video communication session, screen or content (presentation) sharing, launching access to cooperative or independent third party applications (for example remote assistance), etc.

Devices that can be advantageously used herein may include, but are not limited to, a personal computer (PC), which may include but not limited to a home PC, corporate PC, a Server, a laptop, a Netbook, tablet computers, a Mac, touch-screen computers running any number of different operating systems e.g. MS Windows, Apple iOS, Google Android, Linux, Ubuntu, etc. a cellular phone, a Smartphone, a PDA, an iPhone, an iPad, an iPod, an iPad, a PVR, a set top box, wireless enabled Blu-ray player, a TV, a SmartTV, wireless enabled connected devices, e-book readers e.g. Kindle or Kindle DX, Nook, etc. and other such devices that may be capable of text, voice and video communications. Other embodiments of the invention may also use devices like Samsung's Smart Window, Google Glasses, Corning's new glass technologies, and other innovations and technologies that may be applicable to the invention at present or in the future.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here.

The exemplary systems and methods of this disclosure have been described in relation to a computer system, device, server, data structure, etc. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), which may have a single core or multiple cores, memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the Detailed Description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method comprising:
a first device, including a processor, a memory, and a user interface, conduct a first chat session with a second device over a network;
while conducting the first chat session, the first device receiving, through the user interface, a request to initiate a side chat session with a third device;
the first device establishing a first communication channel between the first device and the third device;
the first device providing access to the first communication channel by the third device;
the first device registering the first communication channel with the first chat session;
after registering with the first chat session, the first communication channel receiving a first message from the first chat session;
the first communication channel providing the first message to the third device; and
the first device preserving the anonymity of the third device with respect to the second device.

2. The method according to claim 1, wherein requesting a side chat session comprises:
providing access to a list of two or more devices and/or users to invite into the side chat session;
receiving an identification of the third device in the list; and
inviting the third device into the side chat session.

3. The method according to claim 2, wherein the list is a contacts list stored on the first device.

4. The method according to claim 2, further comprising the third device sending a second message to the first device over the first communication channel, wherein the second message is not sent into the first chat session.

5. The method according to claim 4, wherein second device is unaware that the first device invites the third device into the side chat session.

6. The method according to claim 5, wherein the first device and the third device register with the first communication channel.

7. The method according to claim 6, further comprising:
the first device receiving the second message from third device; and
providing the second message, along with the first message, to a user interface of the first device.

8. The method according to claim 7, further comprising:
the first device receiving a third message from the second device;
providing the third message to the user interface of the first device; and
precluding transmission of the third message to the third device in the side chat session.

9. The method according to claim 7, wherein an identity of the second device is not shared with the third device when providing the second message.

10. The method according to claim 9, wherein providing the first message to the third device further comprises:
receiving selection of the first message in the user interface of the first device;
in response to receiving the selection, transmitting the first message on the first communication channel to the third user.

11. A device comprising:
a user interface that:
displays messages from a chat session;
receives inputs from a user associated with the chat session;
a memory that stores instructions to execute a side chat module;
a processor in communication with the memory and the user interface, wherein the processor retrieves the instructions from the memory, wherein, based on the instructions, the processor:
conducts the first chat session with a second device over a network;
while conducting the first chat session, receives, through the user interface, a request to initiate a side chat session with a third device;
executes the side chat module, wherein the side chat module:
establishes a first communication channel between the first device and the third device;
provides access to the first communication channel by the third device, wherein the first device and the third device register with the first communication channel;
registers the first communication channel with the first chat session;
after registering with the first chat session, provides a first message from the first chat session to the first communication channel, wherein the first communication channel provides the first message to the third device; and
preserves the anonymity of the third device with respect to the second device.

12. The device according to 11, wherein when receiving the request for a side chat session, the user interface:
provides access to a list of two or more devices and/or users to invite into the side chat session, wherein the list is a contacts list stored on the first device, wherein second device is unaware that the first device invites the third device into the side chat session;
receives an identification of the third device in the list; and
sends the identification to the side chat module to invite the third device into the side chat session.

13. The device according to claim 12, wherein the side chat module further:
receives a second message from the third device over the first communication channel, wherein the second message is not sent into the first chat session;
receives the second message from third device; and
provides the second message, along with the first message, to the user interface to display together.

14. The device according to 13, wherein an identity of the second device is not shared with the third device when providing the second message.

15. The device according to claim 14, wherein the side chat module further:
when providing the first message to the third device, receives a signal, indicating a selection of the first message, from the user interface of the first device;
in response to receiving the signal, transmits the first message on the first communication channel to the third user.

16. A user interface method, conducted on a user interface of a first device, the method comprising:
providing a first window associated with a first chat session between the first device and a second device;
displaying a first message, received from the second device, in the first window;
displaying a first user-selectable device, in the first window, to initiate a side chat;
receiving selection of the first user-selectable device to initiate a side chat session with a third device;
after receiving selection of the first user-selectable device and initiation of the side chat session, displaying a second window;
displaying the first message, received from the second device, in the second window;
displaying a second message, received from the third device, in the second window;
displaying, in the second window, a first text entry area to receive text input for a third message to be sent to the first device; and
displaying, in the second window, a second text entry area to receive text input for a fourth message to be sent to the third device.

17. The method according to claim 16, wherein the first user-selectable device is a button, wherein the first user-selectable device is also displayed in the second window, and wherein a visual appearance of the first user-selectable device is different in the second window compared to when the first user-selectable device is displayed in the first window.

18. The method according to claim 17, wherein a second visual appearance of the second message is different from a first visual appearance of the first message.

19. The method according to claim 18, wherein a third visual appearance of the second text entry area is similar to a fourth visual appearance of the second message.

20. The method according to claim 19, wherein the first message and the second message are displayed in the same portion of the second window.
